(19) United States
(12) Patent Application Publication
(10) Pub. No.: US 2025/0020830 A1
(43) Pub. Date: Jan. 16, 2025

(54) Multi-Level Structured Surface for Anti-Glare Application and Associated Methods

(71) Applicant: CORNING INCORPORATED, CORNING, NY (US)

(72) Inventors: Shandon Dee HART, Elmira, NY (US); Karl William KOCH, III, Elmira, NY (US); Jun YANG, Los Gatos, CA (US)

(21) Appl. No.: 18/422,153

(22) Filed: Jan. 25, 2024

Related U.S. Application Data
(60) Provisional application No. 63/442,185, filed on Jan. 31, 2023.

(51) Int. Cl. G02B 1/11

(52) U.S. Cl. CPC G02B 1/11

(57) ABSTRACT

Described in the present disclosure are display articles with scattering regions for reducing glare and associated methods. Within the scattering region, a major surface of the display article comprises a plurality of regions comprising a discrete distribution of heights measured relative to an imaginary base plane extending through the display article and parallel to the first major surface. The discrete distribution of heights comprises at least four heights, with each height occupying a surface area percentage of the scattering region that is within 3% of 100%/n, were n is the number of heights. At least two differences between adjacent heights in the discrete distribution of heights are not equal to one another such that the display article exhibits a specular reflectance spectrum comprising two or more local minima over a wavelength range of interest.

### CROSS-REFERENCE TO RELATED APPLICATIONS

This application claims the benefit of priority under 35 U.S.C. § 119 of U.S. Provisional Application Ser. No. 63/442,185 filed on Jan. 31, 2023, the content of which is relied upon and incorporated herein by reference in its entirety.

### FIELD

The disclosure relates to anti-glare articles and, more particularly, to display articles comprising a surface with a scattering region comprising a plurality of regions disposed at a discrete distribution of heights and arranged in a pattern based on a target scattering pattern.

### BACKGROUND

Substrates transparent to visible light are utilized to cover displays of display articles. Such display articles include smart phones, tablets, televisions, computer monitors, vehicle interior displays and the like. The displays are often liquid crystal displays and organic light emitting diodes, among others. The substrate protects the display, while the transparency of the substrate allows the user of the device to view the display. Glare is the phenomena associated with a degraded viewing experience in the presence of bright light sources. In addition, reflected images not from a bright light source but from the ambient can also contribute to a degraded viewing in displays. For example, a visually distinctive user's own reflected image, or light from the surrounding environment, can result in distraction, reduction in legibility, as well as visual fatigue.

Several techniques have been made to reduce glare, including anti-reflective coatings and anti-glare technologies. An anti-reflection coating can reduce glare by directly reducing the total amount of reflection. However, certain existing anti-reflection coatings may fail to diminish reflections to a great enough extent throughout the visible spectrum to render such reflections unnoticed by users. Anti-glare technologies attempt to spread reflection of light to a large range of angles to reduce the peak intensity of the reflection and render distracting reflected images less distinct to the user. However, reflection at angles that are too large can result in relatively high haze that can reduce the contrast of the displayed images.

Accordingly, an alternative to existing anti-glare and anti-reflective coating technologies that allows favorable control of the angular distribution of scattered light would be beneficial.

### SUMMARY

An aspect (1) of the present disclosure pertains to a display article comprising: a first major surface; a second major surface opposing the first major surface; and a scattering region formed in the first major surface, wherein, within the scattering region, the first major surface comprises a plurality of regions comprising a discrete distribution of heights measured relative to an imaginary base plane extending through the display article and parallel to the first major surface, wherein: the discrete distribution of heights comprises n heights, with n being an even integer greater than or equal to 4, each height in the discrete distribution of heights occupies a surface area percentage of the scattering region that is within 3% of 100%/n, at least two differences between adjacent heights in the discrete distribution of heights are not equal to one another such that the display article exhibits a specular reflectance spectrum comprising two or more local minima over a wavelength range of interest.

An aspect (2) of the present disclosure pertains to a display article according to the aspect (1), wherein: the wavelength range of interest is from 400 nm to 770 nm, and the display article exhibits an average photopic specular reflectance reduction of at least −20 dB for light incident on the first major surface over a range of angles of incidence from 0° to 20°.

An aspect (3) of the present disclosure pertains to a display article according to the aspect (2), wherein the display article exhibits an average photopic specular reflectance reduction of at least −15 dB for light incident on the first major surface over a range of angles of incidence from 0° to 60°.

An aspect (4) of the present disclosure pertains to a display article according to the aspect (3), wherein: n=4 such that the discrete distribution of heights comprises a first height, a second height, a third height, and a fourth height, wherein a difference between the second height and the third height is less than a difference between the first height and the second height.

An aspect (5) of the present disclosure pertains to a display article according to the aspect (4), wherein the difference between the second height and the third height is less half the difference between the first height and the second height.

An aspect (4) of the present disclosure pertains to a display article according to any of the aspects (4)-(5), wherein a difference between the fourth height and the third height is within 5% of a difference between the first height and the second height.

An aspect (7) of the present disclosure pertains to a display article according to any of the aspects (4)-(6), wherein a difference between the first height and the second height is greater than or equal 100 nm and less than or equal to 130 nm and a difference between the second height and the third height is greater than or equal to 25 nm and less than or equal to 35 nm.

An aspect (8) of the present disclosure pertains to a display article according to any of the aspects (1-2), wherein: n is greater than or equal to 8 such that the discrete distribution of heights comprises a first height, a second height, a third height, a fourth height, a fifth height, a sixth height, a seventh height, and an eight height, and a difference between the second height and the third height and a difference between the sixth height and the seventh height are the less than differences between other adjacent pairs of heights in the discrete distribution of heights, wherein at least one of: a difference between the first height and the second height is greater than or equal to 90 nm and less than or equal to 110 nm, a difference between the second height and the third height is greater than or equal to 5 nm and less than or equal to 15 nm, a difference between the third height and the fourth height is greater than or equal to 30 nm and less than or equal to 70 nm, and a difference between the fourth height and the fifth height, is greater than or equal to 50 nm and less than or equal to 90 nm.

An aspect (9) of the present disclosure pertains to a display article according to any of the aspect (1)-(8), wherein the scattering region scatters light in a far-field scattering pattern with a peak scattering angle that is less than or equal to 5.0° over the wavelength range of interest.

An aspect (10) of the present disclosure pertains to a display article according to any of the aspect (1)-(9), wherein one of the plurality of regions is completely surrounded by regions disposed at other heights in the discrete distribution of heights.

An aspect (11) of the present disclosure pertains to a display article according to any of the aspect (1)-(10), wherein the wavelength range of interest is from λₘᵢₙ to λₘₐₓ, wherein λₘᵢₙ is less than or equal to 420 and greater than or equal to 350 nm, wherein λₘₐₓ is greater than or equal to 700 nm and less than or equal to 770 nm, wherein an average transmitted haze of the light incident on the first major surface is less than or equal to 8% over the wavelength range of interest.

An aspect (12) of the present disclosure pertains to a display article according to any of the aspects (1)-(11), wherein the article exhibits a sparkle that is less than or equal to 3% when measured at 140 ppi.

An aspect (13) of the present disclosure pertains to a display article according to any of the aspects (1)-(13), wherein a scattering amplitude of the scattering region at a scattering angle of 4° is less than 10⁻³ times a peak scattering amplitude at specular when the scattering amplitude is averaged over a wavelength range from 400 nm to 770 nm.

An aspect (14) of the present disclosure pertains a display article comprising a first major surface; a second major surface opposing the first major surface; and a scattering region formed in the first major surface, wherein, within the scattering region, the first major surface comprises: a plurality of regions comprising a discrete distribution of heights measured relative to an imaginary base plane extending through the display article and parallel to the first major surface, wherein: the discrete distribution of heights comprises n heights, where n is an even integer greater than or equal to 4, each height nᵢ in the discrete distribution of heights occupies a surface area percentage Aᵢ of the scattering region, each value Aᵢ is within 3% of 100%/n, and differences between adjacent heights in the discrete distribution of heights follow a symmetric pattern about a center height difference of the discrete distribution of heights, and the display article exhibits a specular reflectance spectrum comprising two or more local minima over a wavelength range of interest.

An aspect (15) of the present disclosure pertains to a display article according to the aspect (14), wherein at least two differences between adjacent heights in the discrete distribution of heights are not equal to one another.

An aspect (16) of the present disclosure pertains to a display article according to any of the aspects (14)-(15), wherein the center height difference is the smallest difference between adjacent heights in the discrete distribution of heights, wherein the center height difference is greater than or equal to 10 nm and less than or equal to 80 nm.

An aspect (17) of the present disclosure pertains to a display article according to the aspect (16), wherein: n=8 such that the discrete distribution of heights comprises a first height, a second height, a third height, a fourth height, a fifth height, a sixth height, a seventh height, and an eighth height, a difference between the first height and the second height is greater than or equal to 90 nm and less than or equal to 110 nm, a difference between the second height and the third height is greater than or equal to 5 nm and less than or equal to 15 nm, a difference between the third height and the fourth height is greater than or equal to 30 nm and less than or equal to 70 nm, and a difference between the fourth height and the fifth height, is greater than or equal to 50 nm and less than or equal to 90 nm.

An aspect (18) of the present disclosure pertains to a display article according to any of the aspects (14)-(15), wherein the center height difference is not the greatest difference or the smallest difference between adjacent heights in the discrete distribution of heights.

An aspect (19) of the present disclosure pertains to a display article according to the aspect (18), wherein: n=4 such that the discrete distribution of heights comprises a first height, a second height, a third height, and a fourth height, a difference between the first height and the second height is greater than or equal to 100 nm and less than or equal to 130 nm, and a difference between the second height and the third height is greater than or equal to 20 nm and less than or equal to 40 nm.

An aspect (20) of the present disclosure pertains to a display article according to any of the aspects (14)-(19), wherein a difference between a greatest height in the discrete distribution of heights and a second greatest height in the discrete distribution of heights is a greatest difference between adjacent heights in the discrete distribution of heights

An aspect (21) of the present disclosure pertains to a display article according to any of the aspects (14)-(20), wherein the display article exhibits an average photopic specular reflectance reduction of at least −20 dB for light incident on the first major surface over a range of angles of incidence from 0° to 20°.

An aspect (22) of the present disclosure pertains to a display article according to the aspect (21), wherein the display article exhibits an average photopic specular reflectance reduction of at least −15 dB for light incident on the first major surface over a range of angles of incidence from 0° to 60°.

An aspect (23) of the present disclosure pertains to a display article according to any of the aspects (14)-(22), wherein the scattering region scatters light in a far-field scattering pattern with a peak scattering angle that is less than or equal to 5.0° over the wavelength range of interest.

An aspect (24) of the present disclosure pertains to a display article according to any of the aspects (14)-(23), wherein one of the plurality of regions is completely surrounded by regions disposed at other heights in the discrete distribution of heights.

An aspect (25) of the present disclosure pertains to a display article according to any of the aspects (14)-(24), wherein the wavelength range of interest is from λₘᵢₙ to λₘₐₓ, wherein λₘᵢₙ is less than or equal to 420 and greater than or equal to 350 nm, wherein λₘₐₓ is greater than or equal to 700 nm and less than or equal to 770 nm, wherein an average transmitted haze of the light incident on the first major surface is less than or equal to 8% over the wavelength range of interest.

An aspect (26) of the present disclosure pertains to a method of fabricating a display article, the method comprising: determining a first etching pattern for a first major surface of the display article based on a first target far-field scatting pattern, wherein the first etching pattern comprises a first plurality of regions disposed a first height relative to an imaginary base plane extending through the display article and a second plurality of regions disposed at a second height relative to the imaginary base plane, wherein in the first etching pattern, the first plurality of regions and the second plurality of regions each occupy within 3% of half of a scattering region of the first major surface; determining a second etching pattern for the first major surface based on a second target far-field scatting pattern, wherein the second etching pattern comprises a third plurality of regions disposed a third height relative to an imaginary base plane extending through the display article and a fourth plurality of regions disposed at a fourth height relative to the imaginary base plane, wherein in the second etching pattern, the third plurality of regions and the fourth plurality of regions each occupy within 3% of half of a scattering region of the first major surface; and successively etching a glass substrate of the display article in accordance with the first etching pattern and the second etching pattern so as to form a plurality of regions comprising a discrete distribution of heights measured relative to the imaginary base plane, wherein at least two differences between adjacent heights in the discrete distribution of heights are not equal to one another.

An aspect (27) of the present disclosure pertains a method according to the aspect (26), wherein successively etching the glass substrate comprises: disposing a first etching mask on a major surface of the glass substrate; exposing the major surface to an etchant to etch the major surface to a first etch depth, disposing a second etching mask on the major surface, and exposing the major surface to the etchant to etch the major surface to a second etch depth.

An aspect (28) of the present disclosure pertains a method according to the aspect (27), wherein the first and second etching patterns overlap one another such that a portion of the major surface is exposed to the etchant through both the first etching mask and the second etching mask.

An aspect (29) of the present disclosure pertains a method according to the aspect (28), wherein the first etching mask and the second etching mask are unregistered during the successively etching the glass substrate.

An aspect (30) of the present disclosure pertains a method according to any of the aspects (26)-(29), wherein the first etch depth is not equal to the second depth.

An aspect (31) of the present disclosure pertains a method according to any of the aspects (26)-(30), wherein the first and second etching patterns are identical, but offset and/or translated relative to one another.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a perspective view of a display article with a scattering region, according to one or more embodiments of the present disclosure;

FIG. 2 schematically depicts a plurality of regions of the scattering region of the display article of FIG. 1, according to one or more embodiments of the present disclosure;

FIG. 3 schematically depicts an example height profile of a cross-section of an article in a scattering region, according to one or more embodiments of the present disclosure;

FIG. 4 is a plot of calculated optimal specular reflection suppression associated with patterns of regions having different numbers of heights, according to one or more embodiments of the present disclosure;

FIG. 5 is a plot of photopic vision sensitivity and a spectrum of illumination for testing photopic vision sensitivity, according to one or more embodiments of the present disclosure;

FIG. 6A is a plot of calculated etch depth for a scattering region with two discrete heights and mean specular reflectance reduction as a function of a range of angles of incidence for light on the scattering region, according to one or more embodiments of the present disclosure;

FIG. 6B is a plot of simulated specular reflection reduction as a function of wavelength for the scattering region represented in FIG. 6A over a range of angles of incidence form 0° to 45°, according to one or more embodiments of the present disclosure;

FIG. 6C is a plot of calculated etch depth for a scattering region with four discrete heights and mean specular reflectance reduction as a function of a range of angles of incidence for light on the scattering region, according to one or more embodiments of the present disclosure;

FIG. 6D is a plot of simulated specular reflection reduction as a function of wavelength for the scattering region represented in FIG. 6C over a range of angles of incidence form 0° to 45°, according to one or more embodiments of the present disclosure;

FIG. 6E is a plot of calculated etch depth for a scattering region with eight discrete heights and mean specular reflectance reduction as a function of a range of angles of incidence for light on the scattering region, according to one or more embodiments of the present disclosure;

FIG. 6F is a plot of simulated specular reflection reduction as a function of wavelength for the scattering region represented in FIG. 6E over a range of angles of incidence form 0° to 45°, according to one or more embodiments of the present disclosure;

FIG. 6G is a plot of calculated etch depth for a scattering region with sixteen discrete heights and mean specular reflectance reduction as a function of a range of angles of incidence for light on the scattering region, according to one or more embodiments of the present disclosure;

FIG. 6H is a plot of simulated specular reflection reduction as a function of wavelength for the scattering region represented in FIG. 6G over a range of angles of incidence form 0° to 45°, according to one or more embodiments of the present disclosure;

FIG. 6I is a plot of etch heights calculated via the methods described herein as a function of one another for a four-height design, according to one or more embodiments of the present disclosure;

FIG. 6J is a plot of etch heights calculated via the methods described herein as a function of one another for an eight-height design, according to one or more embodiments of the present disclosure;

FIG. 7A is a flow diagram of a method of fabricating a scattering region in an article, according to one or more embodiments of the present disclosure;

FIG. 7B is a polar plot of a target far-field scattering pattern used to design a scattering region, according to one or more embodiments of the present disclosure;

FIG. 7C is a cross-sectional view of the target far-field scattering pattern depicted in FIG. 7B, according to one or more embodiments of the present disclosure;

FIG. 7D is an example binary phase map for the scattering region obtained via the performance of the methods described herein using the target far-field scattering pattern represented in FIGS. 7B and 7C, according to one or more embodiments of the present disclosure;

FIG. 7E is a polar plot of a target far-field scattering pattern used to design a scattering region, according to one or more embodiments of the present disclosure;

FIG. 7F is a cross-sectional view of the target far-field scattering pattern depicted in FIG. 7E, according to one or more embodiments of the present disclosure;

FIG. 7G is an example binary phase map for the scattering region obtained via the performance of the methods described herein using the target far-field scattering pattern represented in FIGS. 7E and 7F, according to one or more embodiments of the present disclosure;

FIG. 7H is a polar plot of a target far-field scattering pattern used to design a scattering region, according to one or more embodiments of the present disclosure;

FIG. 7I is a cross-sectional view of the target far-field scattering pattern depicted in FIG. 6H, according to one or more embodiments of the present disclosure;

FIG. 7J is an example binary phase map for the scattering region obtained via the performance of the methods described herein using the target far-field scattering pattern represented in FIGS. 7H and 7I, according to one or more embodiments of the present disclosure;

FIG. 8A is a histogram for a scattering region with a discrete distribution of four heights, according to one or more embodiments of the present disclosure;

FIG. 8B is a height profile for the scattering region represented in FIG. 8A, according to one or more embodiments of the present disclosure;

FIG. 8C depicts a plurality of calculated far-field scattering patterns for the scattering region represented in FIGS. 8A and 8B at a plurality of wavelengths, according to one or more embodiments of the present disclosure;

FIG. 9A is a histogram for a scattering region with a discrete distribution of eight heights, according to one or more embodiments of the present disclosure;

FIG. 9B is a height profile for the scattering region represented in FIG. 9A, according to one or more embodiments of the present disclosure;

FIG. 9C depicts a plurality of calculated far-field scattering patterns for the scattering region represented in FIGS. 9A and 9B at a plurality of wavelengths, according to one or more embodiments of the present disclosure;

FIG. 10A is a plot of a calculated specular reflectance achieved via the scattering regions represented in FIGS. 8A-8C and 9A-9C, according to one or more embodiments of the present disclosure;

FIG. 10B is a plot of a calculated specular reflectance reduction achieved via the scattering regions represented in FIGS. 8A-8C and 9A-9C, according to one or more embodiments of the present disclosure;

FIG. 11 is a plot of measured specular reflection reduction achieved by an example article fabricated in accordance with the methods described herein, according to one or more embodiments of the present disclosure; and

FIG. 12 is a plot of measured of small angle scattering intensity as a function of scattering angle for the fabricated example represented in FIG. 11, according to one or more embodiments of the present disclosure.

### DETAILED DESCRIPTION

Referring generally to the figures, described herein are display articles comprising scattering regions that are designed to significantly reduce specular reflectance throughout a wavelength range of interest while still providing relatively low scattering intensities at high scattering angles. Such scattering regions beneficially prevent distinct reflected images from disrupting users' viewing experiences of the display, while still providing favorable image contrast characteristics. Such favorable performance is achieved by structuring a major surface of the display article to comprise a plurality of regions, with each of the regions comprising an area of the major surface that is disposed at a height relative to an imaginary base plane. The plurality of regions are structured such that the heights associated with the regions form a discrete distribution of heights including an even integer (n) of heights that is greater than or equal to 4. Each height in the discrete distribution of heights occupies a surface area percentage of the scattering region that is within 3% of 100%/n, such that each height occupies an approximately equal percentage of the scattering region. Unless expressed otherwise, the surface area percentages expressed herein are a percentage of a surface area extending in a plane parallel to the imaginary base plane (parallel to a lengthwise dimension of the substrate). It is believed that each of the heights occupying an approximately equal percentage of the scattering region facilitates favorable specular reflectance reduction performance. Moreover, at least two differences between adjacent heights in the discrete distribution of heights are not equal to one another such that the article exhibits a specular reflectance spectrum comprising two or more local minima over a wavelength range of interest. Multiple local minima over a suitable wavelength range of interest (e.g., from 400 nm to 700 nm) aids in reducing the overall average specular reflectance over a desired range of angles of incidence of scattered light (e.g., from 0° to 20°, from 0° to 30°, from 0° to 40°, from 0° to 50°, from 0° to 60°, from 0° to 70°).

In aspects, the scattering regions described herein are realized by performing multiple etches on a surface of the article, with each etch being performed with a mask disposed on the surface. The mask has a pattern that is determined based on a phase mask calculated from a target far-field scattering pattern. Successive etches are performed, with each of the etches forming a pattern determined from a target far-field scattering pattern and an etch depth determined via an optimization function described herein to minimize specular reflectance of the article. In embodiments, each of the etches is formed from a target far-field scattering pattern that approximates a Laguerre Gaussian (LG) mode or other suitable function that exhibits a peak scattering angle that is less than or equal to 5.0° such that the scattering region exhibits a far-field scattering pattern with a peak scattering angle that is less than or equal to 5.0° (e.g., less than or equal to 4.0°, less than or equal to 3.0°, less than or equal to 2.5°, less than or equal to 2.0°). Low scattering amplitudes at high scattering angles facilitates favorable haze performance attributes of less than 8% over a wavelength rang of interest from 350 nm to 770 nm or any wavelength range of interest therein (e.g., an average transmission haze of less than or equal to 8.0% when averaged from 400 nm to 700 nm, an average transmission haze of less than or equal to 7.5% when averaged from 400 nm to 700 nm, an average transmission haze of less than or equal to 7.0% when averaged from 400 nm to 700 nm an average transmission haze of less than or equal to 6.5% when averaged from 400 nm to 700 nm, an average transmission haze of less than or equal to 6.0% when averaged from 400 nm to 700 nm).

The scattering regions described herein are beneficial in that the patterns associated with each individual etch step are unregistered with respect to one another. That is, each pattern in each successive etch step may be rotated and/or offset in any way with respect to one another, while still providing the favorable performance attributes described herein. Avoiding the need to particularly position the successive patterns with respect to one another significantly reduces manufacturing difficulties and lowers costs.

As used herein, the term “specular reflectance” refers to the percentage of light reflected from an article at an angle of reflection that is equivalent and opposite in sign to an angle of incidence of the light. For example if light is incident at −20 degrees, the specular reflection will be at an angle of +20 degrees, as known in the art. This specular reflectance may be measured over a certain angular range, for example, within about +/−0.1 degrees from the perfect specular reflection direction. The specular reflectance can be measured as the peak intensity of reflected light from a first surface of a substrate within a cone of angles of +/−0.1°. Specular reflectance may be measured using a Rhopoint IQ meter, which reports an Rs value in Gloss Units (“GU”) normalized to a reference highly polished black glass with a refractive index of 1.567 for the Sodium D line.

As used, herein, the term “haze” or “transmission haze” refers to the percentage of transmitted light scattered outside an angular cone of about ±2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well. For an optically smooth surface, transmission haze is generally close to zero.

As used herein, the terms “sparkle,” “sparkle contrast,” “display sparkle,” “pixel power deviation,” “PPD”, or like terms refers to the visual phenomenon that occurs when a textured transparent surface is combined with a pixelated display. Generally speaking, quantitation of sparkle involves imaging a lit display or simulated display with the textured surface in the field of view. The calculation of sparkle for an area P is equal to σ(P)/μ(P), where σ(P) is the standard deviation of the distribution of integrated intensity for each display pixel contained within area P divided by the mean intensity μ(P). Following the guidance in: (1) J. Gollier, et al., “Apparatus and method for determining sparkle,” US9411180B2, United States Patent and Trademark Office, 20 Jul. 2016; (2) A. Stillwell, et al., “Perception of Sparkle in Anti-Glare Display Screens,” JSID 22(2), 129-136 (2014); and (3) C. Cecala, et al., “Fourier Optics Modeling of Display Sparkle from Anti-Glare Cover Glass: Comparison to Experimental Data”, Optical Society of America Imaging and Applied Optics Congress, JW5B.8 (2020); one skilled in the art can build an imaging system to quantify sparkle. Alternatively, a commercially available system (e.g. the SMS-1000, Display Messtechnik & Systeme GmbH & Co. KG, Germany) can also be used. Unless described otherwise, sparkle is measured with a 140 PPI display using the following procedure. A 140 PPI display (e.g. Z50, Lenovo Group Limited, Hong Kong) with only the green subpixels lit (R=0, B=0, G=255), at full display brightness is imaged using a f=50 mm lens/machine vision camera combination (e.g. C220503 1:2.8 50 mm Φ30.5, Tamron, Japan) and Stingray F-125 B, Allied Vision Technologies GmbH, Germany). The lens settings are aperture=5.6, depth of field=0.3, working distance=about 290 mm; with these settings, the ratio of display pixels to camera pixels is approximately 1 to 9. The field of view for analysis contains approximately 7500 display pixels. Camera settings have the gain and gamma correction turned off. Periodic intensity variations from, e.g. the display, and non-periodic intensity variations, e.g. dead pixels, are removed during analysis prior to the calculation of sparkle.

As used herein, the terms “specular reflection reduction” or “specular reflectance reduction” refer to a relative amount by which a scattering region reduces a specular reflection as compared to an optically smooth article formed of the same material of the display articles described herein. Put differently, specular reflection reduction values are computed relative an article formed of the same material as the display articles described herein, with said comparative articles being untextured to possess the scattering regions described herein. Specular reflection reduction values can be expressed in decibels and computed as a logarithmic ratio between articles with scattering regions and optically smooth articles formed of the same material. Computation of specular reflection reduction will generally result in a negative number (e.g., −10 dB). The phrase “greater than” herein, when used in relation to a specular reflection reduction value, refers to the magnitude of the number (absolute value). Accordingly, in accordance with the present disclosure, a specular reflectance reduction of −20 dB is greater than a specular reflectance reduction of −10 dB. Moreover, a specular reflectance reduction of −20 dB will be within a range of “at least −10 dB.”

Specular reflectance reductions can be expressed as averages over an indicated specular range. These averages are computed as a logarithmic ratio of the average specular reflectance of the scattering region to the average specular reflectance of on optically smooth surface of the same material. Average specular reflectance may be expressed as photopic specular reflectance or “photopic average specular reflectance.” As used herein, photopic specular reflectance mimics the response of the human eye by weighting the reflectance versus wavelength spectrum according to the human eye's sensitivity. Photopic specular reflectance may also be defined as the luminance, or tristimulus Y value of reflected light, according to known conventions such as CIE color space conventions. The average photopic reflectance is defined in Equation (A) as the spectral reflectance, R(λ) multiplied by the illuminant spectrum, I(λ) and the CIE's color matching function y̅(λ), related to the eye's spectral response (the wavelength range of interest for photopic values described herein is from 400 nm to 700 nm):

$$〈 {R}_{p} 〉 = \frac{{\int }_{400 nm}^{770 nm} R ( λ ) {I}_{i l l u m} ( λ ) \overline{y} ( λ ) d λ}{{\int }_{400 nm}^{770 nm} {I}_{i l l u m} ( λ ) \overline{y} ( λ ) d λ} . \qquad ( A )$$

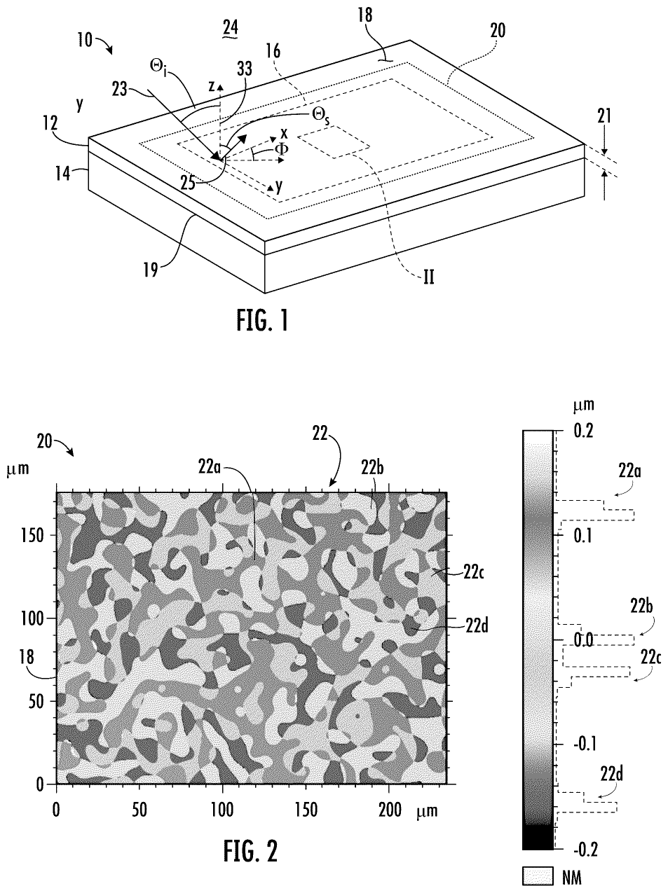

Referring now to FIG. 1, a display article 10 is depicted, according to an example embodiment. The display article 10 comprises a substrate 12. In embodiments, the display article 10 further includes a housing 14 to which the substrate 12 is coupled and a display 16 within the housing 14. In such embodiments, the substrate 12 at least partially covers the display 16 such that light that the display 16 emits can transmit through the substrate 12.

The substrate 12 includes a first major surface 18, a second major surface 19, a scattering region 20 defined on the first major surface 18, and a thickness 21 that the first major surface 18 bounds in part (e.g., representing a minimum distance between the first major surface 18 and the second major surface 19 at a particular point on the first major surface 18). In the depicted embodiment, the substrate 12 is substantially planar is shape such that the first major surface 18 and the second major surface 19 are generally flat (with the exception of the first major surface 18 transitioning between heights, as described herein). Embodiments where the substrate 12 comprises a curved shape (e.g., via suitable hot-forming and cold-forming techniques) are also contemplated and within the scope of the present disclosure. The first major surface 18 generally faces toward an external environment 24 surrounding the display article 10 and away from the display 16. In embodiments, the display 16 emits visible light that transmits through the thickness 22 of the substrate 12, out the first major surface 18, and into the external environment 24.

As depicted in FIG. 1, light from the external environment 24, represented by incoming light ray 23, may be incident on the first major surface 18 at an angle of incidence θᵢ (representing a zenith angle that the incoming light ray 23 extends relative to the surface normal 33 of the first major surface 18, depicted as the z-direction in FIG. 1). The incoming light ray 23 may represent light from a number of different sources from outside of the article 10. For example, the incoming light ray 23 may represent sunlight that is incident on the first major surface 18 or light from another external light source (e.g., light reflected or scattered from an external object, light generated by another source). The scattering region 20 scatters the light represented by the incoming light ray 23 in a scattering direction, represented by the scattered light ray 25. Light is scattered in a particular direction with a scattering amplitude that depends on the angle of incidence θᵢ and a scattering angle θₛ relative to the surface normal 33. As shown, the scattered light ray 25 is scattered in a scattering direction that, when projected into a plane of the first major surface 18 extending perpendicular to the surface normal 33, extends at an azimuthal angle Φ relative to a first direction (the x-direction depicted in FIG. 1).

The scattering region 20 is structured to scatter light originating from the external environment 24 in a scattering pattern that is designed to suppress specular reflectance while also having relatively low scattering amplitudes at scattering angles (θₛ) greater than or equal to 10° (e.g., greater than or equal to 5.0°, greater than or equal to 4.0°, greater than or equal to 3.0°, greater than or equal to 2.5°, greater than or equal to 2.0°). In embodiments, the scattering region 20 is structured to have a far-field scattering pattern with a maximum scattering amplitude at a scattering angle of less than or equal to 10° (e.g., less than or equal to 5.0°, less than or equal to 4.5°, less than or equal to 4.0°, less than or equal to 3.5°, less than or equal to 3.0°, less than or equal to 2.5°, less than or equal to 2.0°, less than or equal to 1.5°, less than or equal to 1.0°, less than or equal to 0.9°, less than or equal to 0.8°, less than or equal to 0.7°, less than or equal to 0.6°, less than or equal to 0.5°) throughout a wavelength range of interest [λₘᵢₙ, λₘₐₓ] over a range of angles of incidence (θᵢ). In embodiments, the scattering region 20 is structured so as to reduce specular reflectance by at least 10 times (e.g., at least 100 times, at least 1000 times, at least 10000 times) relative to a smooth, untextured version of the first major surface 18. By reducing specular reflectance of the substrate 12, while controlling scattering amplitudes at relatively high scattering angles, the structure of the scattering region 20 provides favorable anti-glare and haze performance as compared with certain existing display articles.

As used herein, the term “untextured version,” when used in describing specular reflectance performance of the articles described herein, refers to a specular reflectance predicted using the Fresnel Coefficients associated with an optically smooth surface of the material out of which the substrate 12 is constructed. For example, if the substrate 12 is constructed of a material (e.g., glass or suitable polymeric material) with a refractive index n₁ and the external environment comprises a refractive index n₂ (e.g., of air), the specular reflectance of the untextured version of the substrate 12 may be computed using the following equations:

$${R}_{s} = {\vert \frac{{n}_{1} cos {θ}_{i} - {n}_{2} cos {θ}_{t}}{{n}_{1} cos {θ}_{i} + {n}_{2} cos {θ}_{t}} \vert}^{2} \qquad ( 1 )$$

$${R}_{p} = {\vert \frac{{n}_{1} cos {θ}_{t} - {n}_{2} cos {θ}_{i}}{{n}_{1} cos {θ}_{t} + {n}_{2} cos {θ}_{i}} \vert}^{2} \qquad ( 2 )$$

where θᵢ is an angle of incidence on the first major surface 18, θₜ is the angle of transmission just after the first major surface (determined using Snell's law), Rₛ is the intensity of reflectance for s-polarized light, and Rₚ is the intensity of reflectance for p-polarized light. Unless otherwise specified, the specular reflectance performances herein are averaged for polarization.

FIG. 2 schematically depicts a plane view of the region II of the scattering region 20 of the display article 10 depicted in FIG. 1, according to an example embodiment of the present disclosure. In embodiments, within the scattering region 20, the first major surface 18 comprises a non-uniform structure such that the first major surface 18 comprises surface height deviations measured relative to an imaginary base plane that are greater than a maximum surface roughness value (e.g., Sa value) of portions of the first major surface 18 extending within 2° of parallel to the second major surface 19. The first major surface 18 comprises surface height deviations outside of a range associated with an inherent roughness of the material out which the substrate 12 is formed. As a result of such surface height deviations, within the scattering region 20, the first major surface 18 comprises a plurality of regions 22. Each of the plurality of regions 22 makes up a portion of the first major surface 18 and extends generally parallel to the second major surface 19, while it should be understood that each of the plurality of regions 22 may be slanted relative to the second major surface 19 as a result of the forming processes for the plurality of regions 22 described herein. In embodiments, each of the plurality of regions 22 represents a contiguous portion of the first major surface 18 that does not comprise a surface height deviation outside of a range associated with a surface roughness of the first major surface 18. Each of the plurality of regions 22 comprises a portion of the first major surface 18 that is disposed at a common height (e.g., within a tolerance associated with forming processes) relative to an imaginary base plane extending through the substrate 12. Each of the plurality of regions 22 is adjacent to at least one other one of the plurality of regions 22 comprising a portion of the first major surface 18 that is disposed at a different height relative to the imaginary base plane than that region. Ones of the plurality of regions 22 comprising the same height relative to the imaginary base plane may be separated from one another by at least one other one of the plurality of regions disposed at a different height relative to the imaginary base plane. Boundaries of each of the plurality of regions 22 are demarcated by contours where abrupt changes (e.g., greater than 20 nm or greater than 50 nm) in surface height are observed on the first major surface 18.

In embodiments, the plurality of regions 22 can be characterized as being planar in the sense that, within each of the regions, the surface height of the first major surface 18 does not substantially vary. For example, in embodiments, within a particular one of the plurality of regions 22, the surface height variation (or roughness) may be less than 50 nm, in terms of root-mean-square (RMS) variation (or less than 20 nm RMS, or less than 10 nm RMS). For example, in these embodiments, each of the plurality of first regions 22a, the plurality of second regions 22b, the plurality of third regions 22c, and the plurality of fourth regions 22d can be characterized by a surface height variation from 0.1 nm RMS to 50 nm RMS, from 0.1 nm RMS to 20 nm RMS, from 0.1 nm RMS to 10 nm RMS, or from 0.1 nm RMS to 1 nm RMS. There may also be a small amount of height variation within each region that is not typically described as roughness, but may be associated with surface curvature or feature rounding created during an etching fabrication process. These variations may lead to a max-min height variation withing each region of from 0.1 nm to 20 nm, from 0.1 nm to 10 nm, or from 0.1 nm to 1 nm. Even with these height variations, the discrete number and average separation of surface heights can be clearly distinguished using known surface profiling techniques such as optical interferometry or stylus profilometry.

As described herein, the plurality of regions 22 forming the scattering region 20 are arranged in a predetermined pattern that is calculated based on a target far-field scattering pattern exhibiting low amplitudes of specular reflectance for light incident on the first major surface 18 from the external environment 24 and low scattering amplitudes at scattering angles greater than 2° (e.g., greater than 5°, greater than 10°). The predetermined pattern is generally not discernable through observation via the naked eye, but rather identified using the methods described herein. The plurality of regions 22 may vary substantially in size and shape over the scattering region 20. For example, in embodiments, a maximum linear dimension (a length of a longest line segment connecting portions of the perimeter of a region to one another without intersecting another portion of the perimeter) of the plurality of regions 22 can vary from 1 to 10 microns to 100 s of microns and can also extend in a variety of different directions for each region.

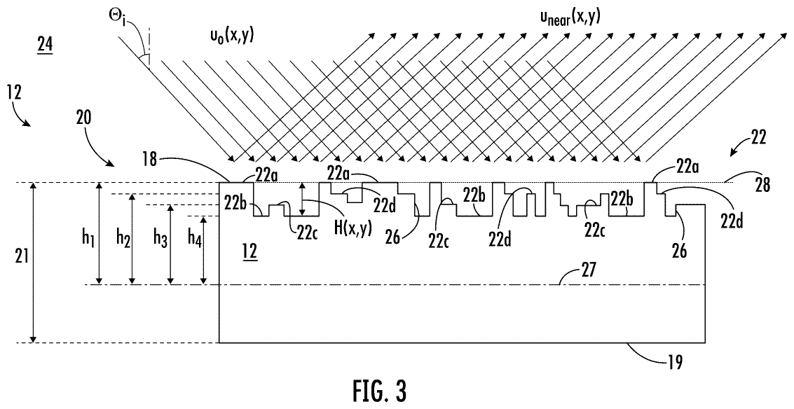

FIG. 3 schematically depicts a simplified cross-sectional view of the scattering region 20. The cross-sectional view depicted in FIG. 3 is conceptual and simplified for the purposes of discussion and does not correspond to the actual pattern depicted in FIG. 2. As shown in FIG. 3, the plurality of regions 22 comprise portions of the first major surface 18 that are disposed at a discrete distribution of heights measured relative to an imaginary base plane 27 extending through the substrate 12 and parallel to the first major surface 18 (with each region comprising a section of the first major surface 18 extending generally parallel to the imaginary base plane 27, allowing for manufacturing tolerances). In embodiments, the plurality of regions 22 comprises a plurality of first regions 22a where the first major surface 18 is disposed at a first height h₁ measured as a distance in a direction perpendicular to the imaginary base plane 27, a plurality of second regions 22b disposed at a second height h₂ relative to the imaginary base plane 27, a plurality of third regions 25c disposed at a third height h₃ relative to the imaginary base plane 27, and a plurality of fourth heights 25d disposed at a fourth height h₄ relative to the imaginary base plane 25. While in the depicted example the scattering region 20 includes regions disposed at a discrete distribution of heights comprising four heights, it should be understood that embodiments with greater number of heights are contemplated and within the scope of the present disclosure. Generally, the plurality of regions 22 may be disposed at n heights relative to the imaginary base plane, where n is an even integer greater than or equal to 4. Regions depicted in FIG. 3 to be disposed at the same height relative to one another (e.g., ones of the first regions 22a) may be disposed at slightly different heights due to variations in etching of the substrate 12. Generally, each of the first regions 22a, second regions 22b, third regions 22c, and fourth regions 22d comprise average heights that are within 5% a minimum height at which one of those regions is disposed relative to the imaginary base plane 27.

The imaginary base plane 27 is not a physical component of the substrate 12, but rather an imaginary reference plane extending through the substrate 12. In embodiments, the imaginary base plane 27 extends through a geometric center of the substrate 12. In the depicted embodiment, the first plurality of regions 22a of the first major surface 18 represent points on the first major surface 18 that are disposed a maximum distance from the imaginary base plane 27, such that the thickness 21 has a maximum value when measured within the first plurality of regions 22a. The precise heights that the each of the first plurality of regions 22a may deviate slightly from h₁. In embodiments, h₁ represents an average measured height of the first plurality of regions 22a and the heights of each of the first plurality of regions 22a is within 5% of h₁. The same goes for other heights in the discrete distribution of heights. In embodiments, the discrete distribution of heights at which the first major surface 18 is disposed relative to the imaginary base plane 27 may include any number of heights (e.g., 4 heights, 6 heights, 8 heights, 16 heights, or an even greater number of heights). As described herein, adjacent heights in the discrete distribution of heights differ from one another by non-uniform amounts. For example, in embodiments, h₁−h₂≠h₂−h₃. Such a non-uniform distribution of the discrete distribution of heights is believed to aid in reducing the specular reflectance of the scattering region 20 by providing a plurality of local minima in a specular reflectance spectrum over a wavelength range of interest [λₘᵢₙ, λₘₐₓ]. As described herein, the heights in the discrete distribution of heights are determined based on desired performance attributes for the article 10, including the wavelength range of interest over which specular reflectance is desired to be minimized as well as a range of angles of incidence [θᵢₘᵢₙ, θᵢₘₐₓ] over which such specular reflectance reduction is desired. This non-uniform distribution of the discrete distribution of heights is also believed to aid in enabling a fabrication process where the first etch pattern is unregistered (e.g. can be randomly placed) relative to a second etch pattern, which greatly improves manufacturing efficiencies and enables lower cost fabrication processes.

As shown in FIG. 3, the plurality of regions 22 of the first major surface 18 are separated from one another by transition surfaces 26 of the substrate 12. The transition surfaces 26 represent segments of an exterior surface of the substrate 12 that extend at a substantial angle (e.g., greater than 20°) relative to the imaginary base plane 27. The transition surfaces 26 represent points where a surface height of the first major surface 18 deviates outside of a range associated with a surface roughness of the first major surface 18. The length of each of the transition surfaces 26 depends on the pattern of the plurality of regions 22 (i.e., which heights in the discrete distribution of heights are disposed adjacent to one another). In embodiments, at least some of the transition surfaces 26 extend perpendicular (or within 10° of perpendicular) to the imaginary base plane 27. Such transition surfaces 26 that extend perpendicular to the imaginary base plane 27 may have lengths corresponding to differences between adjacent heights of the discrete distribution of heights (e.g., h₁−h₄, h₁−h₂, h₂−h₃).

As will be appreciated, each region in the first plurality of regions 22a may be disposed at a height that differs slightly from h₁, each region in the second plurality of regions 22b may be disposed at a height that differs slightly from h₂, each region in the third plurality of regions 22c may be disposed at a height that differs slightly from h₃, and each region in the fourth plurality of regions 22d may be disposed at a height that differs slightly from h₄ due to manufacturing tolerances. As such, the heights h₁, h₂, h₃, and h₄ may represent manufacturing targets for forming the scattering region 20 using any of the methods described herein. In embodiments, each region of the first plurality of regions 22a, the second plurality of regions 22b, the third plurality of regions 22c, and the fourth plurality of regions 22d is disposed at a height that is within 5% of its target value. In embodiments, if an average surface height for each region of the first plurality of regions 22a, the second plurality of regions 22b, the third plurality of regions 22c, and the fourth plurality of regions 22d is measured, and each set of average values associated with each height in the discrete distribution of heights is averaged, the averaged value of each set may be within 5% of the manufacturing target value.

In embodiments, a combined surface area of each of the plurality of regions 22 at each height in the discrete distribution of heights occupies a predetermined combined surface area percentage of the scattering region 20. In the depicted example, the first plurality of regions 22a occupies a first combined surface area percentage of the scattering region 20, the second plurality of regions 22b occupies a second combined surface area percentage of the scattering region 20, the third plurality of regions 22c occupies a third combined surface area percentage of the scattering region 20, and the fourth plurality of regions 22d occupies a fourth combined surface percentage of the scattering region 20. In embodiments, each of the first combined surface area percentage, the second combined surface area percentage, the third combined surface area percentage, and the fourth combined surface area percentage are within 3% of 100%/n, where n represents a total number of heights in the discrete distribution of heights. That is, each height in the discrete distribution of heights occupies a substantially equal surface area within the scattering region 20. It is believed that each height occupying a similar portion of the scattering region 20 aids in providing superior specular reflectance reduction performance.

The pattern in which the plurality of regions 22 are arranged may be determined using scalar diffraction theory and a suitable algorithm, as described herein. As shown in FIG. 3, incoming radiation from the external environment 24 may be approximated as uniform planewave approximated as

$${u}_{0} ( x , y ) = \sqrt{{I}_{0}} {e}^{i ( {k}_{x 0} x + {k}_{y 0} y )} \qquad ( 3 )$$

where Iₒ represents a uniform intensity of incoming radiation and kₓₒ and k_{yo} represent wave vectors associated with the wavelength of the radiation and the angle of incidence on the first major surface 18 (e.g., the angle of incidence may be broken up into components in the x and y directions based on the azimuthal angle Φ, as shown in FIG. 1). In such a case, the scalar near field for the outgoing radiation (after interaction with the first major surface 18) can be approximated as

$${u}_{n e a r} ( x , y ) = ρ {u}_{0} ( x , y ) \cdot {e}^{i ϕ ( x , y )} \qquad ( 4 )$$

where ρ is the Fresnel coefficient of the interface (computed using Equation 1 or Equation 2, depending on the polarization of the incoming radiation), and

$$ϕ ( x , y ) = \frac{2 π}{λ} 2 H ( x , y )$$

is the local phase accumulated through the double passage of the distance to the first major surface 18, H(x, y), with H(x,y) representing the pattern in which the plurality of regions 22 are arranged (H(x,y) represents the distribution of heights as measured from an imaginary plane 28 extending at the height hₘₐₓ and parallel to the imaginary base plane 27, but is related to the heights h₁, h₂, h₃, and h₄). In this example, incoming radiation is approximated as having a uniform intensity distribution and the interface between the substrate 12 and the external environment 24 is approximated as only applying a spatially varying phase such that the outgoing radiation in the near field also has a uniform intensity distribution.

In this example depicted in FIG. 3, the far-field scattering pattern associated with the outgoing radiation may be represented in the reciprocal k space and is related to the near field uₙₑₐᵣ(x, y) computed using Equation 4 through a Fourier transform and expressed as

$${u}_{far} ( {k}_{x} , {k}_{y} ) = [ {u}_{n e a r} ( x , y ) ] = \int \int {dxdye}^{- i ( {k}_{x} x + {k}_{y} y )} {u}_{n e a r} ( x , y ) . \qquad ( 5 )$$

In embodiments, the pattern in which the plurality of regions 22 is arranged is selected so that H(x,y), when input into Equation 5, substantially matches a target far-field distribution. In embodiments, the target far-field distribution is selected to provide relatively low levels of specular reflection and low scattering amplitudes at angles greater than or equal to 5.0°. One set of target far-field distributions may be mathematically described by the Laguerre-Gaussian (“LG”) modes. In embodiments, another target far-field scattering distribution may be described mathematically as a function of a scatting angle θ (relative to specular) as

$$I ( θ ) = {( \frac{θ}{w {′}_{θ}} )}^{l} {e}^{- {( \frac{θ}{w {′}_{θ}} )}^{α}} . \qquad ( 6 )$$

where l is an azimuthal index, α is a stretching parameter, and w′_{θ}is determinative of an angle w_{θ}associated with a peak scattering amplitude in accordance with the following relation

$${w}_{θ}^{′} = {w}_{θ} / {( \frac{1}{α} )}^{\frac{1}{α}} . \qquad ( 7 )$$

In embodiments, the value for the stretching parameter α is greater than 1.0 (e.g., greater than or equal to 1.25, greater than or equal to 1.5, greater than or equal to 2.0). It has been found that such stretching parameter values aid in providing color uniformity of the scattered light. The azimuthal index l determines the order of the zero at specular reflection and alters the shape of the intensity distribution of the scattered light. In embodiments l is an integer greater than or equal to 1.0. In embodiments, the angle w_{θ} is selected to be less than or equal to 5° (e.g., less than or equal to 4°, less than or equal to 3°, less than or equal to 2°, less than or equal to 1.5°, less than or equal to 1.0° ) to aid in limiting the transmission haze of the resultant glass article. The target far-field scattering distribution may be used in a suitable algorithm to determine the pattern for the plurality of regions 22, as described herein.

In embodiments, the objective to reduce specular reflection occurs over a wavelength range of interest of wavelengths greater than or equal to a minimum wavelength of interest λₘᵢₙ and less than or equal to a maximum wavelength range of interest λₘₐₓ. λₘᵢₙ and λₘₐₓ may vary depending on the application. For example, an objective in one application may be to minimize specular reflectance over from the visible to the near infrared, such that λₘᵢₙ=380 nm and λₘₐₓ=1200 nm. In another example, it may only be desired to limit specular reflectance over the visible spectrum, such that λₘᵢₙ=380 nm and λₘₐₓ=700 nm. Any suitable wavelength range of interest may be used. In embodiments, λₘᵢₙ=350 nm, 360 nm, 370 nm, 380 nm, 390 nm, 400 nm, 410 nm, 420 nm, 430 nm, or anywhere between such values; and λₘₐₓ=680 nm, 690 nm, 700nm, 710 nm, 720 nm, 730 nm, 740 nm, 750 nm, 760 nm, 770 nm, 780 nm, 800 nm, 900 nm, 1000 nm 1100 nm, 1200 nm, or anywhere between such values.

In embodiments, the objective to reduce specular reflection occurs over a variety of angles of incidence θᵢ (see FIG. 3). That is, for a particular display application, it may be advantageous to provide anti-glare functionality over a wide range of angles of incidence θᵢ to prevent reflected images from being noticeable to users from a variety of different angles. In embodiments, for example, it may be desired to minimize specular reflection at angles of incidence ranging from θᵢₘᵢₙ to θᵢₘₐₓ. In embodiments, θᵢₘᵢₙ=0°, 5°, 10° or 20°. In embodiments, θᵢₘₐₓ=70°, 60°, 50°, 45°, 40°, 35°, 30°, 25°, 20°, 15°, 10°, or 5°. In view of the foregoing, the objective to reduce specular reflectance may be understood as minimizing specular reflection over a wavelength range of interest of [λₘᵢₙ, λₘₐₓ] at a plurality of angles of incidence within the range [θₘᵢₙ, θₘₐₓ] (with square brackets indicating the boundaries of the ranges being included). Such a problem may be simplified in reciprocal k-space as minimizing specular reflection for wavevectors k between kₘᵢₙ′ and kₘₐₓ′. That is, the objective to minimize specular reflectance may be understood as minimizing specular reflectance between kₘᵢₙ′ and kₘₐₓ′, where

$$\\ {k}_{min}^{{}_{} ′} = \frac{2 π * cos {θ}_{imin}}{{λ}_{min}} and {k}_{max}^{{}_{} ′} = \frac{2 π * cos {θ}_{imax}}{{λ}_{max}} .$$

With reference to FIG. 3, the combined surface area percentage for each height hᵢ in the distribution of heights of the plurality of regions 22 can be expressed as a value Aⱼ, with j denoting a reference integer. One can also provide the constraint that Σⱼ₌₁^{N}Aⱼ=1, such that the plurality of regions 22 occupies 100% of the surface area of the first major surface 18 in the scattering region 20. In such cases, and in view of Equations 3-5, it can be established that the object to minimize specular reflectance can be mathematically expressed as minimizing a function proportional to ƒ(A, h), expressed as

$$\\ \begin{matrix}f ( A , h ) ≡ {\int }_{{k}_{min}^{{}_{} ′}}^{{k}_{max}^{{}_{} ′}} dk \cdot g ( k ) {\vert {\sum }_{j = 1}^{N} {A}_{j} \cdot {e}^{{}_{} ik 2 {h}_{j}} \vert}^{2} & ( 8 )\end{matrix}$$

where Aⱼ and hⱼ are free parameters in the optimization and g(k) is a spectral weight function. In embodiments, the scattering region 20 is restricted to a surface that can be realized by multiple etch steps (M etch steps, where M is an integer greater than or equal to 2), where each etch step is configured as a binary pattern with two different heights differing from one another by an etch depth. In such embodiments, each particular binary pattern associated with a single etch step may have a fill faction fᵢ associated with a particular surface height, with the surface heights being separated from one another by an etch depth h₁. If the etch patterns are assumed to be completely randomly rotated and offset with respect to one another, then it can be shown that Equation 8 becomes

$$\\ \begin{matrix}F ( \{ {A}_{j} , {H}_{j} \} ) = F ( \{ {f}_{l} , {h}_{l} \} ) = {A}^{{}_{} 2} {\int }_{{k}_{min}^{{}_{} ′}}^{{k}_{max}^{{}_{} ′}} dk \cdot g ( k ) {\prod }_{l = 1}^{M} {\vert {f}_{l} \cdot {e}^{{}_{} 2 {ikh}_{l}} + ( 1 - {f}_{l} ) \vert}^{2} & ( 9 )\end{matrix}$$

when it is assumed that the summation of the areas Aⱼ in Equation 8 equal a total area A of the scattering region 10. As shown by Equation 9, the function for optimization is a product of the patterns associated with each etch step. When Equation 9 is optimized via the condition

$$\\ \frac{\partial F ( \{ {f}_{l} , {h}_{l} \} )}{\partial {f}_{p}} = 0 ,$$

it becomes apparent that ƒₗ for each etch step should be 50%. Inputting such a value, Equation 8 can be further simplified as

$$\\ \begin{matrix}F ( \{ {A}_{j} , {H}_{j} \} ) = F ( \{ {f}_{l} , {h}_{l} \} ) = constant * {\int }_{{k}_{min}^{{}_{} ′}}^{{k}_{max}^{{}_{} ′}} dk \cdot g ( k ) {\prod }_{l = 1}^{M} {cos}^{{}_{} 2} {kh}_{l} . & ( 10 )\end{matrix}$$

Further optimizing for the etch depths h₁ via the other optimal condition

$$\\ \frac{\partial F ( \{ {h}_{l} \} )}{\partial {h}_{p}} = 0$$

leads to M independent equations

$$\\ \begin{matrix}{\int }_{{k}_{min}^{{}_{} ′}}^{{k}_{max}^{{}_{} ′}} dk \cdot g ( k ) ( - sin 2 {kh}_{p} ) {\prod }_{l \neq p}^{M} {cos}^{{}_{} 2} {kh}_{l} = 0. & ( 11 )\end{matrix}$$

When g(k)=1/k, corresponding to sampling k uniformly in logarithmic scale, the equation can be analytically calculated. On the other hand, if g(k) is some other function that is given, for example if g(k) corresponds to human eye sensitivity response, then Eqn. (11) can be numerically solved.

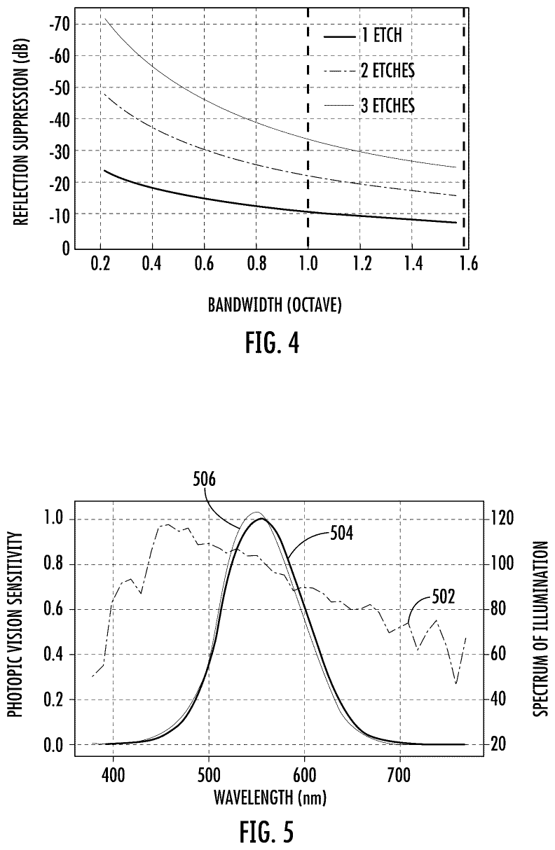

When g(k)=1/k, the optimal reflection reduction, given a certain bandwidth and number of levels, can be calculated. The numerical results are depicted in FIG. 4. FIG. 4 depicts computed ideal specular reflection and reduction (as compared to an untextured version of the first major surface 18) for a plurality of distributions of heights for the plurality of regions 22 (with each distribution containing a different number of heights) for a plurality of different wavelength ranges of interest (expressed in units of octaves=log₂(λₘₐₓ/λₘᵢₙ)). As shown in FIG. 4, for a wavelength range of interest of 400 nm to 800 nm (corresponding to 1 octave), two discrete heights reduces specular reflection by about 10 dB as compared to the untextured version, whereas four discrete heights reduces specular reflection by about 20 dB and eight discrete heights reduces specular reflection by about 32 dB, as compared to an untextured version of the glass substrate. These values may serve as guidance for the number of levels needed for a given application.

In embodiments, the spectral weight function g(k) used to determine the desired etch depths for each etching step (and therefore the heights in the discrete distribution of heights) may be adjusted based on the human eye sensitivity response. FIG. 5 depicts a plot including a first curve 502 representing a typical spectrum of illumination used to test human visual sensitivity, a second curve 504 representing photopic vision sensitivity of the human eye, and a third curve 506 representing the product of the first curve 502 and the second curve 504. In embodiments, when determining the discrete distribution of heights based on photopic visual sensitivity Equation 10 becomes

$$\\ \begin{matrix}{\int }_{{θ}_{imin}}^{{θ}_{imax}} d {θ}_{i} {\int }_{{λ}_{min}}^{{λ}_{max}} d λ \cdot g ( λ ) {\prod }_{l = 1}^{M} cos ( \frac{4 π {h}_{l} cos {θ}_{i}}{λ} ) & ( 12 )\end{matrix}$$

where g(λ) is represented by the third curve 506 depicted in FIG. 5. This equation can be solved analytically to reveal the optimal etch depth h₁ for each etch step and the discrete distribution of heights. The curve 502 may represent a spectrum of illumination used to determine photopic measurements described herein (unless otherwise specified, the spectrum of illumination is a D65 light source).

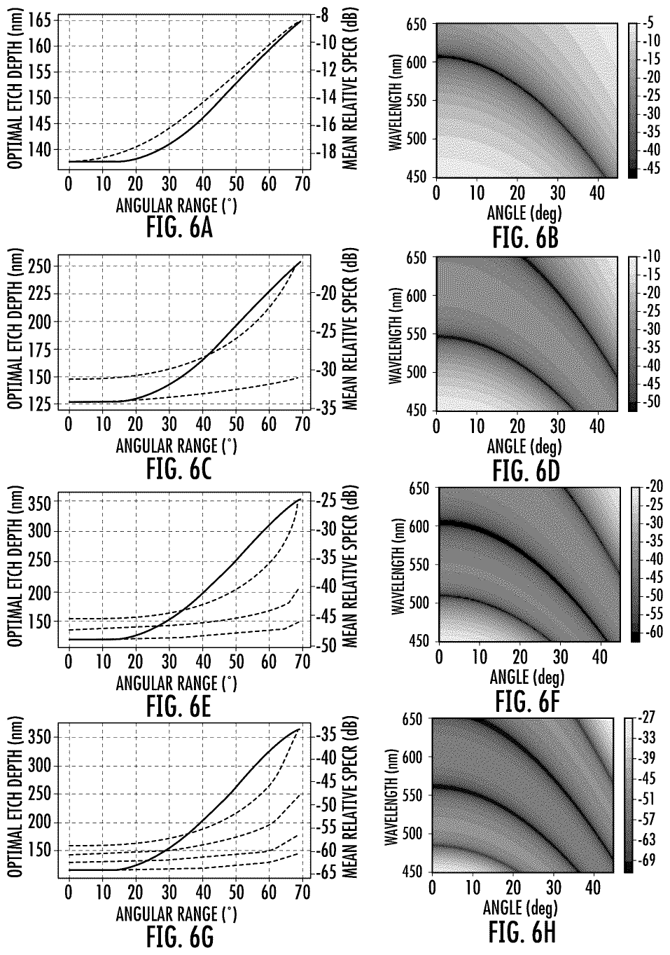

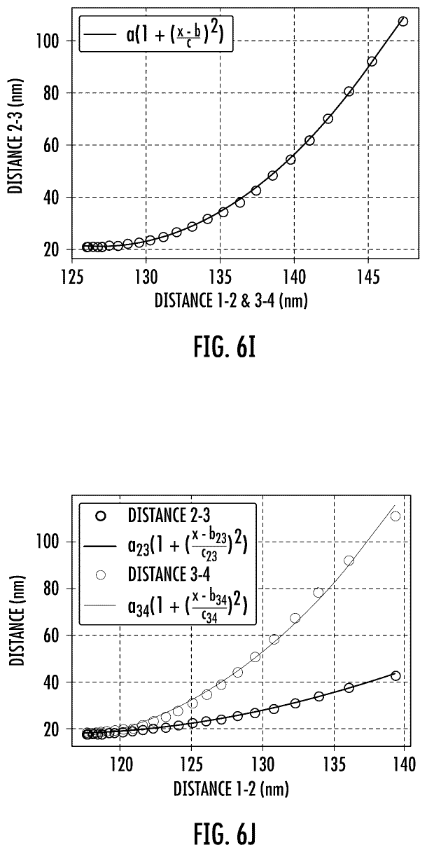

FIGS. 6A-6D summarize results when computing optimal etch depths using Equation 12 with g(λ) being represented by the third curve 506 in FIG. 5. FIGS. 6A and 6B show the results for a counter example with a single etching step optimized for a plurality of ranges of angle of incidences. As shown in FIG. 6A, the optimal etch depth increases as θᵢₘₐₓ increases, while the mean photopic average specular reflection reduction decreases as θᵢₘₐₓ increases. That is, specular reflection reduction tends to be reduced as the angular range of incidence increases. FIG. 6B depicts simulated photopic average specular reflection reduction (in dB relative to an untextured surface) as a function of angle of incidence and wavelength for the case when the range of angles of incidence is [0°, 45°]. FIGS. 6C and 6D show similar plots for an example including two etches. As shown in FIG. 6C, as θᵢₘₐₓ increases, the difference between the target etch depths increases. In the two etch step example, as the difference between the etch depths in the successive etch steps increases, the difference between h₂ (e.g., determined by the etch depth of the first etch step) and h₃ (e.g., determined by the etch depth of the second etch step) generally increases. As shown in FIG. 6D, at a particular angle of incidence, the specular reflection reduction spectrum comprises two local minima (at 30°, for example, the local minima are centered at about 470 nm and 620 nm. Generally, specular reflectance spectra of the articles described herein will comprise a number of local minima that equals a number of etching steps used to fabricate the article. FIG. 6E and 6F show optimal etch depths for a three etch design and specular reflectance reduction as a function of wavelength and angle of incidence when optimized for a ranges of angles of incidence is [0°, 45°], respectively, while FIGS. 6G and 6H show similar plots for a four etch example.

With reference to FIG. 6C and FIG. 3, for the two etch examples having four heights (h₁, h₂, h₃, and h₄) in the discrete distribution of heights, it can be shown that h₁−h₂=h₃−h₄, while h₂−h₃≠h₁−h₂. The plurality of first regions 22a represent regions of the first major surface 18 that are not contacted with an etchant in both etch steps. The plurality of second regions 22b represent regions of the first major surface 18 that are contacted by etchant only during the etch step having the smaller target etch depth. The plurality of third regions 22b represent regions of the first major surface 18 that are contacted by etchant only during the etch step having the larger target etch depth. The plurality of fourth regions 22d represent regions of the first major surface 18 that are contacted by etchant during both etch steps. Accordingly, the quantities h₁−h₂ and h₃−h₄ both correspond to the smaller target etch depth, while h₂−h₃ corresponds to a difference between the smaller and larger etch depths. Differences between adjacent heights in the discrete distribution of heights may follow a symmetric pattern about a center height difference (e.g., h₂−h₃ in the four-height case, h₄−h₅ in the eight-height case, etc.) as a result of the computations via Equation 12.

FIG. 6I depicts values for h₂−h₃ as a function of values for h₁−h₂ and h₃−h₄ from the results in FIG. 6C. A polynomial fit between the values that heights may vary in accordance with the following relation

$$\\ \begin{matrix}{h}_{23} = a * ( 1 + {( \frac{{h}_{12} - b}{c} )}^{2} ) , & ( 13 )\end{matrix}$$

where a=20.84 nm, b=127.26 nm, c=9.84 nm. FIG. 6J depicts values for h₂−h₃ and h₃−h₄ as a function of the value h₁−h₂ for the three etch case based on the results depicted in FIG. 6D. A polynomial fit between the values that the heights may vary in accordance with the following relations:

$$\\ \begin{matrix}{h}_{23} = {a}_{23} * ( 1 + {( \frac{{h}_{12} - {b}_{23}}{{c}_{23}} )}^{2} ) , and & ( 14 )\end{matrix}$$

$$\\ \begin{matrix}{h}_{34} = {a}_{34} * ( 1 + {( \frac{{h}_{12} - {b}_{34}}{{c}_{34}} )}^{2} ) , & ( 15 )\end{matrix}$$

where a₂₃=16.85 nm, b₂₃=114.08 nm, c₂₃=20.38 nm; a₃₄=16.30 nm, b₃₄=115.72 nm, c₃₄=9.60 nm. That is, the optimal etch depths may approximately vary depending on the above relations in order to achieve optimal specular reflection reduction.

As is represented by the Equations 13-15, for a particular design, the heights in the discrete distribution of heights are related to one another. As a result, once a first etch depth is selected for a particular design, which determines h₁₂ in Equations 13-15, the other etch depths can be determined. The first etch depth, which may determine the height h₂, may be selected based on the ranges of angles of incidence over which specular reflectance reduction is sought to be maximized. For a photopic case where two etches are desired, FIG. 6C can be used as a starting point. As shown in FIG. 6C, when specular reflectance is sought to be minimized over an angular range of 0° to 30°, the first etch depth may be less than or equal to 130 nm (e.g., greater than or equal to 100 nm and less than or equal to 130 nm, greater than or equal to 105 nm and less than or equal to 130 nm, greater than or equal to 110 nm and less than or equal to 130 nm, greater than or equal to 120 nm and less than or equal to 130 nm). For example, the first etch depth may be approximately 100 nm, 101 nm, 102 nm, 103 nm, 104 nm, 105 nm, 106 nm, 107 nm, 108 nm, 109, nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, or 130 nm, and any values in between such values. The particular target etch depth may be selected depending on desired performance attributes associated with a particular application (e.g., a specular range). The Equations 13-15 may provide a starting point, but actual values used may vary from those output by the Equations 13-15 depending on performance objectives associated with the application. In such an example, the second etch depth, determined approximately by Equation 12, may be less than or equal to 175 nm (e.g., greater than or equal to 140 nm and less than or equal to 175 nm, greater than or equal to 145 nm and less than or equal to 160 nm, greater than or equal to 150 nm and less than or equal to 160 nm). For example, the second etch depth may be approximately 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 156 nm, 157 nm, 158 nm, 159 nm, 160 nm, 161 nm, 162 nm, 163 nm, 164 nm, 165 nm, 170 nm, 171 nm, 172 nm, 173 nm, 174 nm, 175 nm, or anywhere between such values. As a result, h₂₃ may vary between 10 nm and 75 nm for such applications. In embodiments, h₂₃ is greater than or equal to 20 nm and less than or equal to 40 nm (e.g., greater than or equal to 25 nm and less than or equal to 35 nm) or approximately 28 nm, 29 nm, 30 nm, 31 nm, 32 nm, 33 nm, or anywhere between such values. It should be understood that, in these examples, the phrase, “first etch depth” describes the smallest etch depth in the etching steps that are performed. Such an etching step may or may not be the first etching step in actually fabricating a sample (e.g., the largest etch depth may actually occur first).

In embodiments, for 3-etch designs, the first etch depth may be less than that selected for a 2-etch design to facilitate distributing local minima in specular reflection over the specular range of interest. As shown in FIG. 6G, for example, when minimizing photopic specular reflectance over an angular range of 0° to 30°, the first etch depth (determine h₁₂) may be less than or equal to 120 nm (e.g., less than or equal to 115 nm, less than or equal to 110 nm). For example, the first etch depth (or h₂) may be approximately 100 nm, 101 nm, 102 nm, 103 nm, 104 nm, 105 nm, 106 nm, 107 nm, 108 nm, 109 nm, 110 nm, or anywhere between such values. As a result, as depicted in FIG. 6G, the second etch depth (or h₃) may be greater than the first etch depth and less than or equal to 150 nm (e.g., less than or equal to 147 nm, less than or equal to 145 nm, less than or equal to 142 nm, less than or equal to 140 nm) such that h₂₃ is less than or equal to 40 nm, less than or equal to 35 nm, less than or equal to 30 nm, less than or equal to 25 nm, less than or equal to 25 nm. In examples, the second etch depth or (h₃) may be approximately 125 nm, 126 nm, 127 nm, 128 nm, 129 nm, 130 nm, 131 nm, 132, nm, 133 nm, 134 nm, 135 nm, 136 nm, 137 nm, 138 nm, 139 nm, 140 nm, or anywhere between such values. Finally, the third etch depth may be greater than the second etch depth and less than or equal a sum of the first and second etch depths (greater than or equal to h₃ and less than or equal to h₂+h₃). In embodiments, the third etch depth may be less than or equal to 200 nm (e.g., less than or equal to 190 nm, less than or equal to 180 nm, less than or equal to 170 nm, less than or equal to 160 nm, less than or equal to 150). In examples, the third etch depth may be approximately 155 nm, 160 nm, 165 nm, 170 nm, 175 nm, 180 nm, 185 nm, 190 nm, 195 nm, or anywhere between such values. As described herein, h₂ is equal to the first etch depth relative to h₁, h₃ is equal to the second etch depth relative to h₁, h₄ is equal to the third etch depth relative to h₁, h₅ is equal to a sum of the first and second etch depths relative to h₁, h₆ is equal to a sum of the first and third etch depths relative to h₁, h₇ is equal to a sum of the second and third etch depths relative to h₁, and h₈ is equal to a sum of the first, second, and third etch depths relative to h₁. This provides a symmetrical distribution of heights where differences between adjacent heights follows a symmetrical distribution about the central distance h₄₅. Differences between adjacent heights can be expressed as h₂₃=h₆₇=a difference between the first and second etch depths; h₃₄=h₅₆=a difference between the second etch depth and the third etch depths; and h₄₅=a difference between the third etch depth and a sum of the first and second etch depths. In embodiments, h₁₂>h₄₅>h₃₄>h₂₃, as a result of the second etch depth being closer to the first etch depth than the second etch depth. In embodiments, h₂₃ is approximately 5 nm, 6 nm, 7 nm, 8 nm, 9 nm, 10 nm, 11 nm, 12 nm, 13 nm, 14 nm, 15 nm, or anywhere between such values. In embodiments, h₃₄ is approximately 30 nm, 32 nm, 34 nm, 36 nm, 38 nm, 40 nm, 42 nm, 44 nm, 46 nm, 48 nm, 50 nm, 52 nm, 54 nm, 56 nm, 58 nm, 60 nm, 62 nm, 64 nm, 66 nm, 68 nm, 70 nm, or anywhere between such values. In embodiments, h₄₅ is approximately 50 nm, 52 nm, 54 nm, 56 nm, 58 nm, 60 nm, 62 nm, 64 nm, 66 nm, 68 nm, 70 nm, 72 nm, 74 nm, 76 nm, 78 nm, 80 nm, 82 nm, 84 nm, 86 nm, 88 nm, 90 nm, or anywhere between such values.

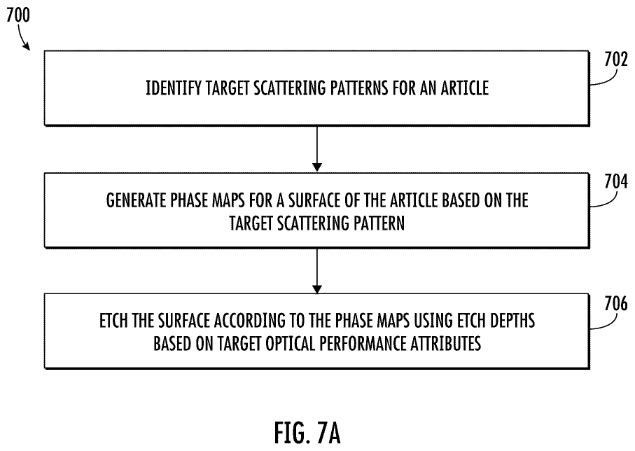

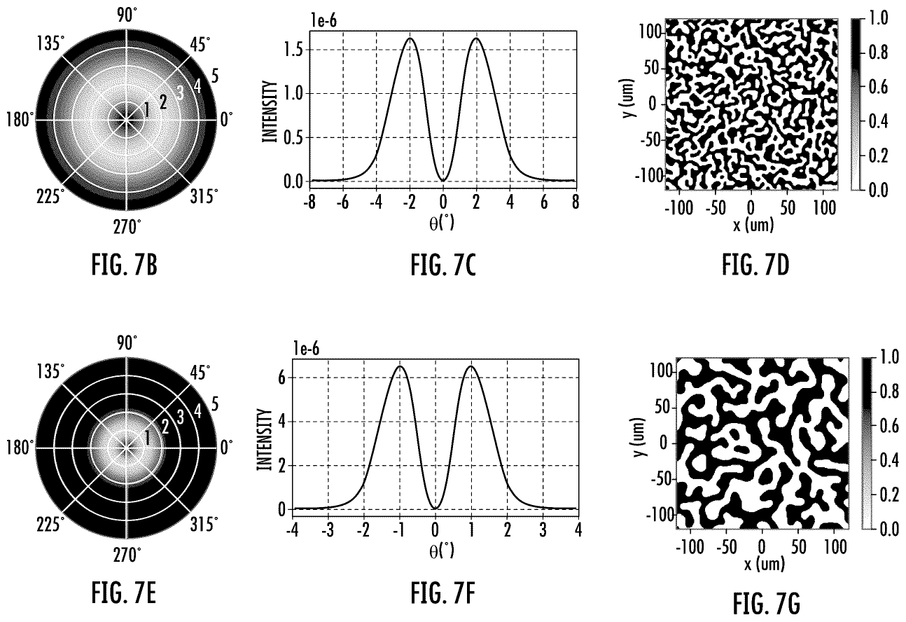

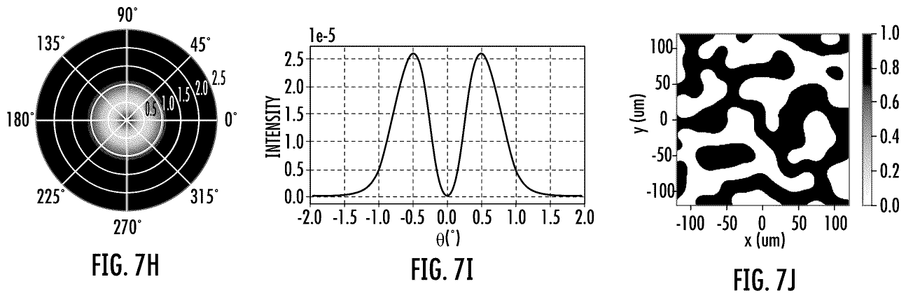

Referring again to FIGS. 1-3, the plurality of regions 22 in the first major surface 18 may be formed using any suitable technique. FIG. 7A depicts a flow diagram of an example method 700 of fabricating the display article 10, according to an example embodiment of the present disclosure. Reference to various components depicted in FIGS. 1-3 will be made to aid in describing the method 700. It should be understood that the particular method used to form scattering region 20 is not particularly limiting and that any suitable method may be used.

At block 702, a target scattering pattern for an article is identified. As described herein, the scattering region 20 may be formed by performing two or more successive etch steps. An initial determination may include determining the number of etch steps needed for a particular application. Reference may be made to, for example, FIG. 4 to determine a number of etches needed based a desired amount of specular reflection reduction for a particular application. The range of angles of incidence over which specular reflection is desired to be suppressed may also determine the number of etch steps desired, as demonstrated via FIGS. 6A-6H.

In embodiments, each etch pattern, associated with the j^{th} etch step, may be defined as a pattern pⱼ(x, y), where pⱼ(x, y) is either 0 or 1 depending on whether that area is etched or unetched in the j^{th} etch step. In such cases, the height map associated with that etch step may be expressed as

$$\\ \begin{matrix}h ( x , y ) = {\sum }_{j = 1}^{M} {p}_{j} ( x , y ) * {h}_{j} , & ( 16 )\end{matrix}$$

where hⱼ is the etch depth for the j^{th} etch pattern. Accordingly, Equations 8-9 can be rewritten in view of the following relations

$$\\ \begin{matrix}[ {e}^{{}_{} i \frac{4 π}{λ} h ( x , y )} ] = [ {e}^{{}_{} i \frac{4 π}{λ} {\sum }_{j = 1}^{M} {p}_{j} ( x , y ) * {h}_{j}} ] & ( 17 )\end{matrix}$$

$$\\ [ {e}^{{}_{} i \frac{4 π}{λ} h ( x , y )} ] = [ {\prod }_{j = 1}^{M} {e}^{{}_{} i \frac{4 π}{λ} {p}_{j} ( x , y ) * {h}_{j}} ]$$

$$\\ [ {e}^{{}_{} i \frac{4 π}{λ} h ( x , y )} ] = ⊗ {\prod }_{j = 1}^{M} [ {e}^{{}_{} i \frac{4 π}{λ} {p}_{j} ( x , y ) * {h}_{j}} ] .$$

That is, the far-field distribution is a convolution of all the far-field distributions for each individual etch step. Thus, instead of designing multiple etch pattern simultaneously to realize a certain far-field distribution, one can design independently each pattern to realize a different far-field distribution, and make sure that the convolution of the far-fields together matches the target far-field distribution (or at least some key attributes of the target far-field distribution).

In view of the foregoing, in embodiments, at block 702, a target far-field scattering pattern may be selected for each etch step. In embodiments, the same target far-field scattering pattern may be used for each of the etch steps (so that the same etching pattern is used in successive etching steps). In embodiments, different far-field scattering patterns may be used for each successive etch step. For example, in embodiments, the far-field scattering patterns may be Equation 6 with different parameters values used in each step. As long as the convolution of the target patterns for each step possess desired attributes (e.g., having minimum values at specular reflection and a peak scattering angle less than or equal to 5° or less than or equal to 2°), any suitable target far-field scattering pattern can be used.

FIG. 7B, FIG. 7E, and FIG. 7H are each polar plots (as a function of the azimuthal angle Φ depicted in FIG. 1) of different far-field scattering patterns that may be used to generate patterns for etching masks in accordance with the methods described herein. Each of the far-field scattering patterns depicted in FIGS. 7B, 7E, and 7H represents the expression in Equation 6 with a different peak scattering angle (associated with the w′_{θ}value in Equation 6). FIGS. 7C, 7F, and 7I are cross sectional plots (for a particular value of Φ) for each of the expressions represented in FIGS. 7B, 7E, and 7I. As shown in FIG. 7C, the expression represented in FIG. 7C has a peak scattering angle (θₛ) of 2°. As shown in FIG. 7F, the expression represented in FIG. 7E has a peak scattering angle (θₛ) of 1°. Such expressions are representative of target far-field scattering patterns that may be used to determine a pattern for a particular etching step.

Referring again to FIG. 7A, at block 704, once target far-field scattering patterns for each etch step is identified, phase maps are generated for each etch step. For each step, the target far-field scattering pattern is input into a suitable algorithm to determine a phase distribution

$$\\ ϕ ( x , y ) = \frac{2 π}{λ} 2 H ( x , y )$$

in Equations 4-5 to provide the desired far-field scattering pattern. As described herein, the H(x, y) term represents the height of the first major surface 18 relative to the imaginary base plane 27 within the scattering region 20. Suitable algorithms that may be used include iterative phase retrieval algorithms, such as the Gerchberg-Saxton algorithm. The Gerchberg-Saxton algorithm may find a source phase distribution (associated with the first major surface 18 within the scattering region 20) by successively applying inverse Fourier and Fourier transforms to source and target amplitude distributions and updating the phase term until the source phase distribution generates the target PSD within a predetermined error criterion. The output of such an iterative phase retrieval algorithm can then be used to calculate a height pattern for the first major surface 18 in the scattering region 20.

In embodiments, as described herein with respect to FIGS. 2-3, the scattering region 20 comprises a plurality of regions of the first major surface 18, where each of the plurality of regions is disposed at a height relative to the imaginary base plane 27. The heights at which the plurality of regions are disposed relative to the imaginary base plane 27 may form a discrete distribution of heights (represented by the heights h₁ and h₂ depicted in FIG. 3). To formulate such a distribution of heights, discretization may be applied during iterations of the phase retrieval algorithm. Any error resulting from the discretization can be included in the optimization in the following iterations, and thus can be mitigated. In embodiments, target phase values ϕ are converted to modified phase values ϕ′ during each iteration using the following equation

$$\\ \begin{matrix}{ϕ}^{{}_{} ′} = Arg [ Re [ {e}^{{}_{} i ϕ} ] + iw Im [ {e}^{{}_{} i ϕ} ] ] , & ( 18 )\end{matrix}$$

where w is a weighting parameter between [1, ∞). Effectively, the imaginary part of the phasor e^{iϕ}is increased in order to align it more and more to the imaginary axis, until only phase values of either

$$\\ + \frac{π}{2} or - \frac{π}{2}$$

are output by the algorithm. In embodiments, the weighting parameter w is gradually changed from 1 to ˜5 over the total number of iterations. Once the binary phase pattern is determined, an etch height (determined via Equations 8-12) is added. The iterative phase retrieval will generally result in each phase having a 50% fill fraction of the scattering region 20.

FIGS. 7D, 7G, and 7F are two-dimensional representations of portions of patterns generated via methods described herein with respect to the block 704, starting from the target far-field scattering patterns depicted in FIGS. 7B, 7E, and 7H, respectively. As shown, the size of the features is generally inversely proportional to the peak scattering angle associated with a particular far-field scattering pattern. As described herein with respect to the Examples, different ones of the patterns represented in FIGS. 7D, 7G, and 7J can be combined via successive etches to generate a scattering region in accordance with the present disclosure.

At block 706, the first major surface 18 is etched according to the phase maps generated at the block 704. Etching may include successively depositing and patterning resists on the first major surface and, after deposition of each resist, pattern the resist according to the phase mask to etch the first major surface 18 to a target etch depth determined via the methods described herein. The nature of the deposition and patterning of the resist may vary depending on the fabrication technique used. In embodiments, various nanoimprint or photolithographic techniques may be used to deposit and pattern the resist layer. In such embodiments, a minimum feature size (e.g., minimum linear dimension) associated with the plurality of regions 22 may be set to at least 1 μm (e.g. greater than or equal to 1.5 μm, greater than or equal to 2.0 μm, greater than or equal to 2.5 μm, greater than or equal to 5.0 μm, greater than or equal to 10 μm) to facilitate use of existing resist application and patterning techniques. In embodiments, for example, the resist may be formed using thermoplastic nanoimprint lithography, and the resist may be formed of a thermoplastic polymer that is spin-coated onto the substrate 12 and subsequently imprinted via a mold to form a first pattern that at least partially corresponds to the pattern for the plurality of regions 22 on the first major surface 18. The resist may be subsequently thermally cured to form an etching mask. Other methods of forming the resist (e.g., Gravure offset printing, other printing techniques) are also contemplated and within the scope of the present disclosure.

Photolithography (e.g., photo imprint nanolithography, optical photolithography) techniques may also be used, and the resist may be deposited onto the first major surface 18 via a suitable application method (e.g., spin coating). In such embodiments, a mask comprising a first pattern at least partially corresponding to the pattern determined for the plurality of regions 22 is aligned with the first major surface 18, and the resist may be exposed to radiation from a suitable light source (e.g., UV radiation) to cause the resist to cure and form an etching mask. The resist may subsequently be developed such that portions of the first major surface 18 are left exposed through the cured resist. Any suitable photolithographic technique may be used to pattern the resist. In embodiments, the pattern formed in an initial resist may be such that areas of the first major surface 18 that are covered by the resist form at least some of the first plurality of regions 22a, disposed at the height h₁, described with respect to FIG. 3.

In embodiment, exposed areas of the first major surface 18 (through the cured and patterned resist) are exposed to a suitable etchant for a suitable etchant period determined based on a target etch depth. Each area of the first major surface 18 that is exposed through the patterned resist formed in the block 704 may directly contact the etchant, which may degrade the substrate and remove material therefrom to form regions on the first major surface 18 that are disposed at a diminished height relative to the imaginary base plane 27 as compared to areas of the first major surface 18 that are covered by the patterned resist. In embodiments, the etchant that contacts the first major surface 18 is an HF/HNO₃ etchant. In embodiments, the etchant consists of hydrofluoric acid (HF, 49 w/w %) and nitric acid (HNO₃, 69 w/w %) combinations with 0.1-5 v/v % HF and 0.1-5 v/v % HNO₃. Typical concentrations used to achieve the etching depths discussed herein are 0.1 v/v % HF/1 v/v % HNO₃ to 0.5 v/v % HF/1 v/v % HNO₃ solutions. In embodiments, the etching can be carried out using a dip or spray etching process from room temperature to about 45° C.

After an initial etching step, subsequent etching steps may be performed by deposition and patterning of additional etch masks on the pre-etched first major surface. As described herein, a benefit of the surfaces described herein is that the etch patterns for each etch step need not be registered with respect to one another. Since a target scattering pattern is calculated for each individual etch step, the etch steps need not combine with one another to form an exact combined pattern. This beneficially renders the manufacturing of the scattering regions described herein easier than in certain existing surfaces.

### Substrate Properties

Various properties of the substrate 12 will now be described, according to embodiments of the present disclosure.

In embodiments, the substrate 12 is a glass substrate or a glass-ceramic substrate. In embodiments, the substrate 12 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 12 is selected from the group consisting of aluminosilicate glass, a borosilicate glass, and a phosphosilicate glass. In other implementations, the bulk composition of the substrate 12 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 12 is a glass-based substrate, including, but not limited to, glass-ceramic materials that comprise a glass component at about 90% or greater by weight and a ceramic component. In other implementations of the display article 10, the substrate 12 can be a polymer material, with durability and mechanical properties suitable for the development and retention of the scattering region 20.

In embodiments, the substrate 12 has a bulk composition that comprises an alkali aluminosilicate glass that comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio (Al₂O₃ (mol %)+B₂O₃ (mol %))/Σ alkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂O₃ (mol %)+B₂O₃ (mol %))/Σ alkali metal modifiers (mol %)>1, where the modifiers are alkali metal oxides.

In embodiments, the substrate 12 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO.

In embodiments, the substrate 12 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≤Li₂O+Na₂O+K₂O≤20 mol % and 0 mol %≤MgO+Ca≤10 mol %.

In embodiments, the substrate 12 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≤SiO₂+B₂O₃+CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂O₃≤2 mol %; 2 mol % ≤Na₂O—Al₂O₃≤6 mol %; and 4 mol %≤(Na₂O+K₂O)—Al₂O₃≤10 mol %.

In embodiments, the substrate 12 has a bulk composition that comprises SiO₂, Al₂O₃, P₂O₅, and at least one alkali metal oxide (R₂O), wherein 0.75>[(P₂O₅(mol %)+R₂O (mol %))/M₂O₃(mol %)]≤1.2, where M₂O₃=Al₂O₃+B₂O₃. In embodiments, [(P₂O₅(mol %)+R₂O (mol %))/M₂O₃ (mol %)]=1 and, in embodiments, the glass does not include B₂O₃and M₂O₃=Al₂O₃. The substrate 12 comprises, in embodiments: about 40 to about 70 mol % SiO₂; 0 to about 28 mol % B₂O₃; about 0 to about 28 mol % Al₂O₃; about 1 to about 14 mol % P₂O₅; and about 12 to about 16 mol % R₂O. In some embodiments, the glass substrate comprises: about 40 to about 64 mol % SiO₂; 0 to about 8 mol % B₂O₃; about 16 to about 28 mol % Al₂O₃; about 2 to about 12 mol % P₂O₅; and about 12 to about 16 mol % R₂O. The substrate 12 may further comprise at least one alkaline earth metal oxide such as, but not limited to, MgO or CaO.

In some embodiments, the substrate 12 has a bulk composition that is substantially free of lithium; i.e., the glass comprises less than 1 mol % Li₂O and, in other embodiments, less than 0.1 mol % Li₂O and, in other embodiments, 0.01 mol % Li₂O, and in still other embodiments, 0 mol % Li₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In embodiments, the substrate 12 has a bulk composition that comprises, consists essentially of or consists of a glass composition, such as Corning® Eagle XG® glass, Corning® Gorilla® glass, Corning® Gorilla® Glass 2, Corning® Gorilla® Glass 3, Corning® Gorilla® Glass 4, or Corning® Gorilla® Glass 5.

In embodiments, the substrate 12 has an ion-exchangeable glass composition that is strengthened by either chemical or thermal means that are known in the art. In embodiments, the substrate 12 is chemically strengthened by ion exchange. In that process, metal ions at or near the first major surface 18 of the substrate 12 are exchanged for larger metal ions having the same valence as the metal ions in the glass substrate. The exchange is generally carried out by contacting the substrate 12 with an ion exchange medium, such as, for example, a molten salt bath that contains the larger metal ion. The metal ions are typically monovalent metal ions, such as, for example, alkali metal ions. In one non-limiting example, chemical strengthening of a substrate 12 that contains sodium ions by ion exchange is accomplished by immersing the substrate 12 in an ion exchange bath comprising a molten potassium salt, such as potassium nitrate (KNO₃) or the like. In one particular embodiment, the ions in the surface layer of the substrate 12 contiguous with the first major surface 18 and the larger ions are monovalent alkali metal cations, such as Li⁺ (when present in the glass), Na⁺, K⁺, Rb⁺, and Cs⁺. Alternatively, monovalent cations in the surface layer of the substrate 12 may be replaced with monovalent cations other than alkali metal cations, such as Ag⁺ or the like.

In such embodiments, the replacement of small metal ions by larger metal ions in the ion exchange process creates a compressive stress region in the substrate 12 that extends from the first major surface 18 to a depth (referred to as the “depth of layer”) that is under compressive stress. This compressive stress of the substrate 12 is balanced by a tensile stress (also referred to as “central tension”) within the interior of the substrate 12. In some embodiments, the first major surface 18 of the substrate 12 described herein, when strengthened by ion exchange, has a compressive stress of at least 350 MPa, and the region under compressive stress extends to a depth, i.e., depth of layer, of at least 15 μm below the first major surface 18 into the thickness 22.

Ion exchange processes are typically carried out by immersing the substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt, such as, but not limited to, nitrates, sulfates, and chlorides, of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a substrate 12 having an alkali aluminosilicate glass composition, result in a compressive stress region having a depth (depth of layer) ranging from about 10 μm up to at least 50 μm, with a compressive stress ranging from about 200 MPa up to about 800 MPa, and a central tension of less than about 100 MPa.

As the etching processes that can be employed to create the scattering region 20 of the substrate 12 can remove alkali metal ions from the substrate 12 that would otherwise be replaced by a larger alkali metal ion during an ion exchange process, a preference exists for developing the compressive stress region in the display article 10 after the formation and development of the scattering region 20.

### EXAMPLES

Embodiments of the present disclosure may be further understood in view of the following examples.

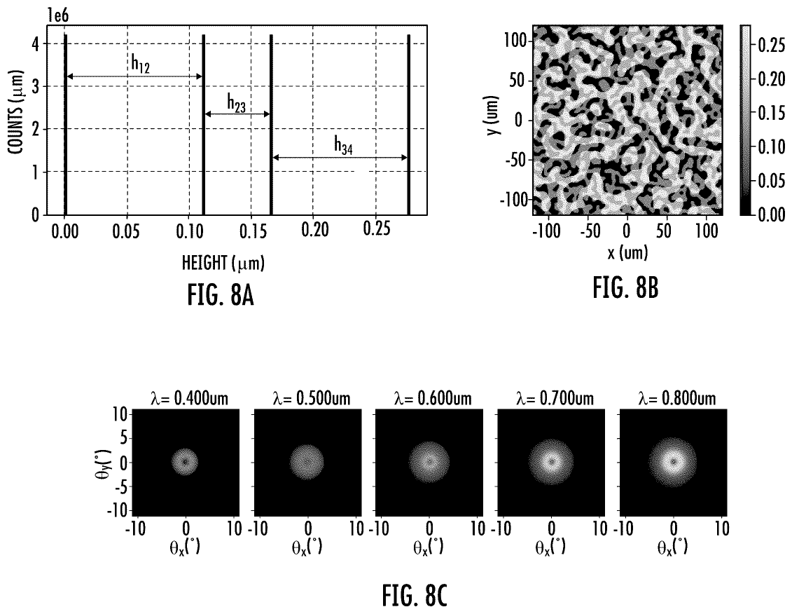

A first pair of examples was constructed using different combinations of the far-field scattering patterns at mask patterns depicted in FIGS. 7B-7I. In a first example, FIG. 8A depicts a height profile associated with a design where the mask pattern depicted in FIG. 7D and the mask pattern depicted in FIG. 7G were overlaid onto one another in two successive etch steps with etch depths of 0.11 μm and 0.165 μm, respectively. FIG. 8B depicts the two mask patterns overlayed on one another. As shown in FIG. 8A, the two etch steps resulted in a discrete distribution of four heights, where h₁−h₂ (h₁₂)=h₃−h₄ (h₃₄)=0.11 μm and h₂−h₃ (h₂₃)=0.055 μm. In this example, h₂₃ represents a center height difference between adjacent heights in the discrete distribution of heights, and the center height distance is the smallest difference between adjacent heights. FIG. 8C are plots of calculated far-field scattering patterns (assuming normally incident light) at various wavelengths for the resulting scattering region depicted to have the height profile represented in FIGS. 8A and 8B. As shown, the combining of different LG modes results in a blurred far-field scattering distribution (as the far-field scattering pattern does exactly approximate equations 6-7) having scattering amplitudes that drop in magnitude at scattering angles above 5° and having relatively low amplitudes at angles near the specular direction.

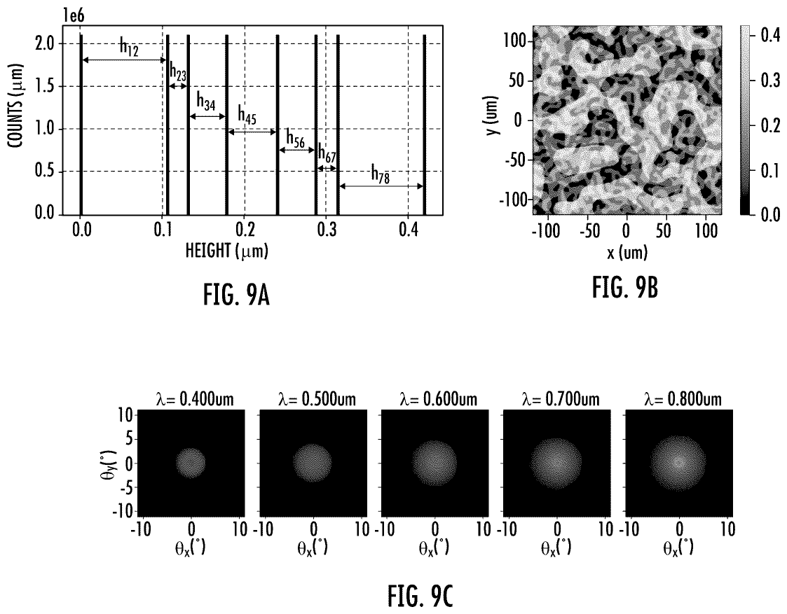

In a second example, FIG. 9A depicts a height profile associated with a design where the mask pattern depicted in FIG. 7D, the mask pattern depicted in FIG. 7G, and the mask pattern depicted in FIG. 7J were overlaid onto one another three two successive etch steps with etch depths of 0.105 μm, 0.12 μm, and 0.18 μm, respectively. FIG. 9B depicts the three mask patterns overlayed on one another. As shown in FIG. 9A, the three etch steps resulted in a discrete distribution of eight heights where h₁−h₂ (h₁₂)=h₇−h₈ (h₇₈)=0.105 μm, h₂−h₃ (h₂₃)=h₆−h₇ (h₆₇)=0.015 μm, h₃−h₄ (h₃₄)=h₅−h₆=0.045 μm, and h₄−h₅=0.06 μm. In the discrete distribution of eight heights, differences between adjacent heights followed a symmetric distribution about a center height h₄₅ (i.e. h₃₄=h₅₆, h₂₃=h₆₇, and h₁₂=h₇₈), which is a characteristic of optimal etch depths calculated by the plots depicted in FIGS. 6I and 6J. In this example, has represents a center height difference between adjacent heights in the discrete distribution of heights, and the center height difference is the neither the greatest nor the smallest difference between adjacent heights. FIG. 9C are plots of calculated far-field scattering patterns (assuming normally incident light) at various wavelengths for the resulting scattering region depicted to have the height profile represented in FIGS. 9A and 9B. As shown, the combining of different LG modes results in a blurred far-field scattering distribution (as the far-field scattering pattern does exactly approximate a particular LG mode) having scattering amplitudes that drop in magnitude at scattering angles above 5° and having relatively low amplitudes at angles near the specular direction.

As shown in FIGS. 8A-8C and 9A-9C, in embodiments, in the discrete distribution of heights, the differences between the greatest height (h₁ as depicted in FIG. 3) and the second greatest height (h₂ as depicted in FIG. 3); and the smallest height (h₄ as depicted in FIG. 3, or h₈) and the second smallest height (h₃ as depicted in FIG. 3, or h₇), are equal to one another and are the greatest differences between adjacent heights in the discrete distribution of heights. Such a characteristic may result from those regions (disposed at the greatest and the least heights) being formed at least partially in an etching step having the greatest etch depth of all the etch steps used to form the scattering region.

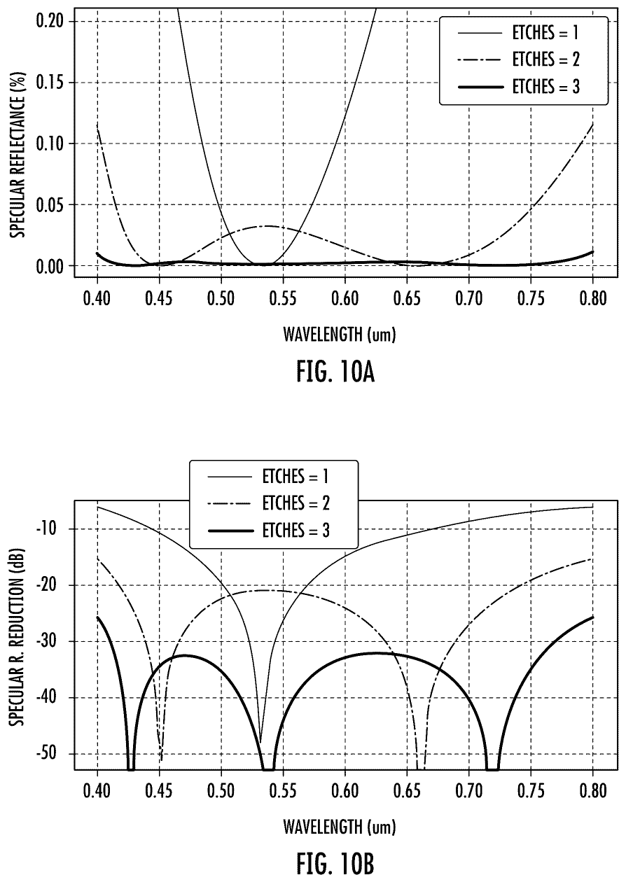

FIGS. 10A and 10B are plots of calculated specular reflectance and specular reflectance reduction (as compared to an untextured version of the articles) of the examples represented in FIGS. 8A-8C and 9A-9C (a counter example formed with the mask pattern depicted in FIG. 7D using an etch depth of 0.135 μm was also modelled). As shown, each of the examples is predicted to have a number of local minima in the specular reflectance spectra that is equal to the number of etch steps used to form that example (i.e., the example with one etch step has a single local minimum over the wavelength range of interest of 400 nm to 800 nm, while the first example has two local minima and the second example has three local minima). As shown in FIG. 10B, the specular reflectance reduction increases in extent with an increased number of etching steps. The single etch counterexample achieved a specular reflectance reduction of about −48 dB at a local minima at 530 nm, but specular reflectance sharply increases at wavelengths less than 500 nm and greater than 575 nm. The first example achieved a specular reflectance reduction of −50 dB at a first local minimum at 450 nm and a specular reflectance reduction of −52 dB at a second local minimum at 655 nm, and, as a result, achieved a lower average specular reflectance (with an average specular reflectance of less than 0.05% throughout the wavelength range from 400 nm to 700 nm and an average specular reflectance reduction of greater than −20 dB). The second example achieved even greater amounts of specular reflection reduction. At local minima at 425 nm, 545 nm, and 720 nm, the specular reflectance reduction was about −55 dB and, as a result, the average specular reflectance was less than 0.01% throughout the wavelength range from 400 nm to 700 nm.

The specular reflection reduction performance achieved via the articles described herein may vary depending on the number of etch steps performed and the range of angles of incidence over which the article is designed to reduce specular reflection. In embodiments, assuming a wavelength range of interest from 400 nm to 700 nm, the articles described herein achieve an average specular reflectance reduction (as compared to an untextured version) of −30 dB over a range of angles of incidence from 0° to 20°. In embodiments, assuming a wavelength range of interest from 40 nm to 70 nm, the articles described herein achieve an average specular reflectance reduction (as compared to an untextured version) of −20 dB over a range of angles of incidence from 0° to 45°. In embodiments, assuming a wavelength range of interest from 380 nm to 720 nm, the articles described herein achieve an average specular reflectance reduction (as compared to an untextured version) of −20 dB over a range of angles of incidence from 0° to 60°.

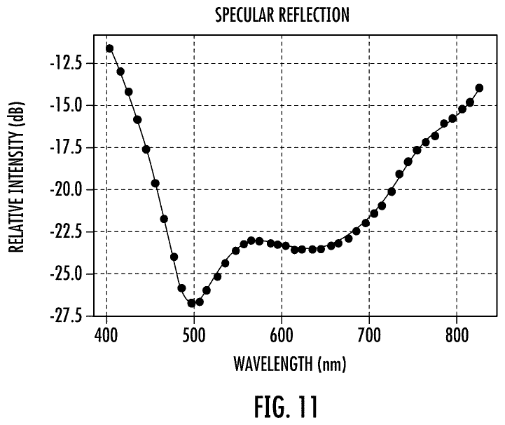

A third example was fabricated in accordance with the principles outlined herein and possess the pattern and height distribution depicted in FIG. 2. Particularly, the pattern for the plurality of regions 22 was generated using Equations 6 and 7 as a target far-field scattering pattern (with l=1, α=1.5, and w_{θ}=1.0°). The same etch mask pattern was used in both etching steps, with the mask being randomly offset and oriented in the second step relative to the first step (offset angle and distance was not measured to be a particular value). Target etch depths of 123.9 nm and 154.5 nm were used in each step. The surface height histogram in FIG. 2 indicates the results measured through a surface profilometer (white light interference). As shown, the heights of the regions roughly match the targets. Specular reflectance reduction was then measured and the resultant spectrum is plotted in FIG. 11. As shown, the specular reflectance spectrum has a first local minimum at about 500 nm and a second local minimum at about 625 nm, and achieves an average specular reflectance reduction of greater than −20 dB over the wavelength range of 400 nm to 720 nm. These results demonstrate the efficacy of the articles described herein in significantly reducing specular reflection while containing scattered light over relatively narrow range of scattering angles about specular to provide improved haze performance over certain existing articles.

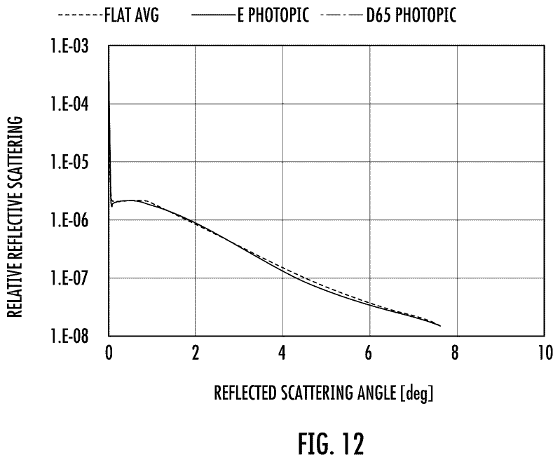

The sample also provided a PPD of 2.85% (at 140 PPI) and a transmission haze of 5.7%. FIG. 12 depicts measured reflected small angular scattering (“SAS”) suppression for the sample represented in FIGS. 2 and 11. The reflectance SAS measurement specular suppression, S(λ) is the relative decrease between the measured reflectance as a ratio to that of an untextured version of the glass, i.e., R_{SUT}(λ)/R_{G}(λ), where R_{SUT}(λ) is the spectral reflectance measurement of the Sample Under Test (of the scattering region) and R_{G}(λ) is the reflectance measurement of the un-textured glass.

FIG. 12 includes plots of three different averages over the wavelength range from 400 nm to 770 nm: a flat (unweighted) average; a flat photopic average (assuming the illumination spectrum in Equation A is flat); and a D65 photopic average (assuming the illumination spectrum in Equation A is that associated with a D65 illuminant). As shown, the scattering regions described herein can achieve a scattering amplitude that is less than 10⁻² times the peak magnitude (at specular) at scattering angles of less than 0.5° relative to the specular direction. Moreover, the scattering regions described herein can achieve a scattering amplitude that is less than 10⁻³ times the peak magnitude at scattering angles that are less than 4° relative to the specular direction. Moreover, the scattering regions described herein can achieve a scattering amplitude that is less than 10⁻⁴ times the peak magnitude at scattering angles that are less than 8° relative to the specular direction. This relatively steep drop-off in scattering amplitude at high scattering angles is believed to be favorable in preventing glare from particular sources from overwhelming display images.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, “a” is intended to comprise one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

1. A display article comprising:
a first major surface;
a second major surface opposing the first major surface; and
a scattering region formed in the first major surface, wherein, within the scattering region, the first major surface comprises a plurality of regions comprising a discrete distribution of heights measured relative to an imaginary base plane extending through the display article and parallel to the first major surface, wherein:
the discrete distribution of heights comprises n heights, with n being an even integer greater than or equal to 4,
each height in the discrete distribution of heights occupies a surface area percentage of the scattering region that is within 3% of 100%/n,
at least two differences between adjacent heights in the discrete distribution of heights are not equal to one another such that the display article exhibits a specular reflectance spectrum comprising two or more local minima over a wavelength range of interest.

2. The display article of claim 1, wherein the display article exhibits an average photopic specular reflectance reduction of at least −15 dB for light incident on the first major surface over a range of angles of incidence from 0° to 60°.

3. The display article of claim 2, wherein:
n=4 such that the discrete distribution of heights comprises a first height, a second height, a third height, and a fourth height,
wherein a difference between the second height and the third height is less than half a difference between the first height and the second height.

4. The display article of claim 3, wherein a difference between the fourth height and the third height is within 5% of a difference between the first height and the second height.

5. The display article of claim 3, wherein a difference between the first height and the second height is greater than or equal 100 nm and less than or equal to 130 nm and a difference between the second height and the third height is greater than or equal to 25 nm and less than or equal to 35 nm.

6. The display article of claim 1, wherein:
n is greater than or equal to 8 such that the discrete distribution of heights comprises a first height, a second height, a third height, a fourth height, a fifth height, a sixth height, a seventh height, and an eight height, and
a difference between the second height and the third height and a difference between the sixth height and the seventh height are the less than differences between other adjacent pairs of heights in the discrete distribution of heights, wherein at least one of:
a difference between the first height and the second height is greater than or equal to 90 nm and less than or equal to 110 nm,
a difference between the second height and the third height is greater than or equal to 5 nm and less than or equal to 15 nm,
a difference between the third height and the fourth height is greater than or equal to 30 nm and less than or equal to 70 nm, and
a difference between the fourth height and the fifth height, is greater than or equal to 50 nm and less than or equal to 90 nm.

7. The display article of claim 1, wherein the scattering region scatters light in a far-field scattering pattern with a peak scattering angle that is less than or equal to 5.0° over the wavelength range of interest.

8. The display article of claim 1, wherein one of the plurality of regions is completely surrounded by regions disposed at other heights in the discrete distribution of heights.

9. The display article of claim 1, wherein the wavelength range of interest is from λₘᵢₙ to λₘₐₓ, wherein λₘᵢₙ is less than or equal to 420 and greater than or equal to 350 nm, wherein λₘₐₓ is greater than or equal to 700 nm and less than or equal to 770 nm, wherein an average transmitted haze of the light incident on the first major surface is less than or equal to 8% over the wavelength range of interest.

10. The display article of claim 1, wherein the article exhibits a sparkle that is less than or equal to 3% when measured at 140 ppi.

11. The display article of claim 1, wherein a scattering amplitude of the scattering region at a scattering angle of less than 4° is less than 10⁻³ times a peak scattering amplitude at specular when the scattering amplitude is averaged over a wavelength range from 400 nm to 770 nm.

12. A display article comprising:
a first major surface;
a second major surface opposing the first major surface; and
a scattering region formed in the first major surface, wherein, within the scattering region, the first major surface comprises:
a plurality of regions comprising a discrete distribution of heights measured relative to an imaginary base plane extending through the display article and parallel to the first major surface, wherein:
the discrete distribution of heights comprises n heights, where n is an even integer greater than or equal to 4,
each height nᵢ in the discrete distribution of heights occupies a surface area percentage Aᵢ of the scattering region,
each value Aᵢ is within 3% of 100%/n, and
differences between adjacent heights in the discrete distribution of heights follow a symmetric pattern about a center height difference of the discrete distribution of heights, and
the display article exhibits a specular reflectance spectrum comprising two or more local minima over a wavelength range of interest.

13. The display article of claim 12, wherein at least two differences between adjacent heights in the discrete distribution of heights are not equal to one another.

14. The display article of claim 12, wherein the center height difference is the smallest difference between adjacent heights in the discrete distribution of heights, wherein the center height difference is greater than or equal to 10 nm and less than or equal to 80 nm.

15. The display article of claim 14, wherein:
n=8 such that the discrete distribution of heights comprises a first height, a second height, a third height, a fourth height, a fifth height, a sixth height, a seventh height, and an eighth height,
a difference between the first height and the second height is greater than or equal to 90 nm and less than or equal to 110 nm,
a difference between the second height and the third height is greater than or equal to 5 nm and less than or equal to 15 nm,
a difference between the third height and the fourth height is greater than or equal to 30 nm and less than or equal to 70 nm, and
a difference between the fourth height and the fifth height, is greater than or equal to 50 nm and less than or equal to 90 nm.

16. The display article of claim 12, wherein the center height difference is not the greatest difference or the smallest difference between adjacent heights in the discrete distribution of heights.

17. The display article of claim 16, wherein:
n=4 such that the discrete distribution of heights comprises a first height, a second height, a third height, and a fourth height,
a difference between the first height and the second height is greater than or equal to 100 nm and less than or equal to 130 nm, and
a difference between the second height and the third height is greater than or equal to 20 nm and less than or equal to 40 nm.

18. The display article of claim 12, wherein a difference between a greatest height in the discrete distribution of heights and a second greatest height in the discrete distribution of heights is a greatest difference between adjacent heights in the discrete distribution of heights

19. The display article of claim 12, wherein the display article exhibits an average photopic specular reflectance reduction of at least −20 dB for light incident on the first major surface over a range of angles of incidence from 0° to 20°.

20. The display article of claim 19, wherein the display article exhibits an average photopic specular reflectance reduction of at least −20 dB for light incident on the first major surface over a range of angles of incidence from 0° to 60°, wherein the scattering region scatters light in a far-field scattering pattern with a peak scattering angle that is less than or equal to 5.0° over the wavelength range of interest, wherein the wavelength range of interest is from λₘᵢₙ to λₘₐₓ, wherein λₘᵢₙ is less than or equal to 420 and greater than or equal to 350 nm, wherein λₘₐₓ is greater than or equal to 700 nm and less than or equal to 770 nm, wherein an average transmitted haze of the light incident on the first major surface is less than or equal to 8% over the wavelength range of interest.
